(19) United States
(12) Patent Application Publication
(10) Pub. No.: US 2025/0109815 A1
(43) Pub. Date: Apr. 3, 2025

(54) EXPANDABLE HEATER

(71) Applicant: BriskHeat Corporation, Columbus, OH (US)

(72) Inventors: Taylor H. Fulton, Reynoldsburg, OH (US); Mabel C. Castellar, Powell, OH (US); Nathan Meisel, Hilliard, OH (US)

(21) Appl. No.: 18/890,596

(22) Filed: Sep. 19, 2024

Related U.S. Application Data
(60) Provisional application No. 63/586,845, filed on Sep. 29, 2023.

(51) Int. Cl. F16L 53/38; H05B 3/56

(52) U.S. Cl. CPC F16L 53/38; H05B 3/56

(57) ABSTRACT

An electric heating element system for heating a pipe is disclosed, having an electrically resistive heating element configured for connection to an electric power source and an approximately rectangular-shaped substrate comprising a length. The substrate includes a first row of slots transverse to the length, a second row of slots transverse to the length and laterally aligned with the first row of slots, a third row of slots transverse to the length and alternatingly positioned along the length relative to the slots in the first and second rows, and a first row of fastener ends and a second row of fastener ends defined by the first row of slots and the second row of slots, respectively. Each of the first and second rows of fastener ends are configured to secure the substrate to the pipe. The substrate's length is adjustable for installation on the pipe.

### CROSS REFERENCE TO RELATED APPLICATIONS

This application claims the benefit of U.S. Provisional Application No. 63/586,845 filed Sep. 29, 2023, which is incorporated by reference herein in its entirety.

### BACKGROUND

The instant disclosure relates generally to heating elements, and particularly to electric heating elements and electric heating element systems for heating, for example, pipes.

Electric heating elements convert electrical energy to heat energy. Heating elements are a type of electric heating devices that have electric resistance wire to release heat when given an electric current. Known heating elements for heating pipes are spirally wound around the pipe from one end to another end of the pipe to provide heat to the pipe in the area in which the heating element is installed. However, known heating elements are difficult to install onto pipes and pipe systems, are unable to easily install on, over, and around obstructions, and are unable to uniformly heat the pipes over their entire surface area. In addition, the length of spirally wound heating element systems is difficult to estimate because a user must take into account the diameter of the pipe as well as the number of winds per unit length of the heating element that is needed to achieve a desired amount of heat to be applied to the given length of pipe. Likewise, removal of known heating elements from a pipe or pipe system is challenging and labor because the user must unwind the heating element from the pipe one wrap at a time, including around obstacles.

Thus, there exists a need for improved heating element systems for easier installation, removal, heat distribution, and estimation of sizes and lengths needed for a given application.

### SUMMARY

Disclosed herein are various embodiments of an electric heating element system. In one embodiment, an electric heating element system for heating a pipe includes an electrically resistive heating element comprising first and second electrical conductors extending from respective opposite ends of the heating element for connection to an electric power source and a substrate comprising a length. The substrate includes: (a) a first row of spaced apart slots transverse to the length; (b) a second row of spaced apart slots transverse to the length and laterally aligned with the first row of spaced apart slots; and (c) a third row of spaced apart slots transverse to the length and alternatingly positioned with the first and second rows of spaced apart slots. The first row of slots defines a first row of spaced apart fastener ends, and the second row of slots define a second row of spaced apart fastener ends opposite the first row of fastener ends. Each of the first and second rows of spaced apart fastener ends are configured to wrap transversely around an outer diameter of the pipe and include a fastener portion for removably attaching respective opposed fastener ends to one another to secure the substrate to the pipe. The heating element is attached to the substrate and serpentines between the first, second, and third rows of spaced apart slots from a first end to a second end of the substrate and from the second end to the first end of the substrate. The first and second electrical conductors are proximate to the first end of the substrate. The first, second, and third rows of slots define rhomboid areas when the substrate is articulated and/or extended along the length.

The electrically resistive heating element may include a self-regulating heating element. The substrate may include a heat resistant fabric or cloth, film, mesh, or non-woven fabric. The fabric, cloth, or film may include a polytetrafluoroethylene (PTFE) coated fiberglass or PTFE film. The substrate may have a substantially rectangular plan form.

The first row of spaced apart fastener ends may be configured to overlap with the second row of spaced apart fastener ends when wrapped around the pipe. The substrate may include a first, unextended length and is extendable to a second, extended length. The maximum extended length may be a function of the slot length. In some embodiments, the second, extended length of the substrate may be up to 80% longer than the first, unextended length. In other embodiments, the second, extended length of the substrate is at least 80% longer than the first, unextended length. The extended length of the substrate may vary to any desired amount up to a predetermined maximum amount. The first row of spaced apart slots may extend from a first outer edge of the substrate along the length toward a longitudinal centerline that bisects the substrate. The second row of spaced apart slots may extend from a second outer edge of the substrate along the length toward a longitudinal centerline that bisects the substrate. The third row of spaced apart slots may extend transverse to the length from a centerline that bisects the substrate toward a first outer edge of the substrate and toward a second outer edge of the substrate.

Each of the fastener portions may include a snap fastener engager or a snap fastener receiver. Alternate options include hook and loop, hook and lace, or bandage clips made of metal or high temperature polymers (such as PEEK or PTFE). The heating element may be attached to the substrate via stitches.

In another embodiment, an electric heating element system for heating a pipe includes an electrically resistive heating element for connection to an electric power source, and a polytetrafluoroethylene (PTFE) fiberglass substrate comprising a length. The substrate includes: (a) a first row of parallel slots transverse to the length; (b) a second row of parallel slots transverse to the length, where each of the slots in the second row are arranged parallel to and laterally aligned with the first row of slots; (c) a third row of parallel slots transverse to the length and alternatingly positioned relative to the slots in the first and second rows; and (d) a first row of fastener ends along the length and a second row of fastener ends along the length opposite the first row of fastener ends, where the first and second rows of fastener ends defined by the first row of slots and the second row of slots, respectively, and where each of the first and second rows of fastener ends are configured to secure the substrate to the pipe. The heating element is attached to the substrate in a serpentine pattern around each of the slots in the first, second, and third rows from a first end to a second end of the substrate and from the second end to the first end of the substrate. The length of the substrate is adjustable.

In various embodiments, the length of the substrate may be adjusted from an unextended length to a fully extended length. In various embodiments, the substrate may be extended to any length between the unextended length and the fully extended length. In various embodiments, the maximum length of the substrate may be a function of the slot length.

The serpentine pattern of the heating element may be repeated along the length of the substrate in a mirror image about a longitudinal centerline of the substrate. The substrate may include a first, unextended length and may be adjustable up to a second, extended length. The substrate may be adjustable to any length from the first, unextended length to a second, extended length. The maximum extended length may be a function of the slot length. In various embodiments, the second, extended length of the substrate may be up to 80% longer than the first, unextended length. The first row of parallel slots may extend from a first outer edge of the substrate along the length toward a longitudinal centerline of the substrate. The second row of parallel slots may extend from a second outer edge of the substrate opposite the first outer edge and along the length toward the centerline. The third row of parallel slots may extend transverse to the length from the centerline toward both the first and second outer edges of the substrate.

In another embodiment, an electric heating element system for heating a pipe includes an electrically resistive heating element configured for connection to an electric power source, and a substantially rectangular-shaped substrate comprising a length. The substrate includes (a) a first row of slots transverse to the length; (b) a second row of slots transverse to the length and laterally aligned with the first row of slots; (c) a third row of slots transverse to the length and alternatingly positioned along the length relative to the slots in the first and second rows; and (d) a first row of fastener ends and a second row of fastener ends defined by the first row of slots and the second row of slots, respectively. Each of the first and second rows of fastener ends are configured to secure the substrate to the pipe. The heating element is attached to the substrate and serpentines around the first, second, and third rows of slots from a first end to a second end of the substrate and from the second end to the first end of the substrate. The substrate is variably adjustable to any desired length from an unextended length to an extended length.

Various embodiments of the instant disclosure may include friction-inducing materials and/or mechanisms to minimize or prevent movement of the heating element system once installed on a pipe to be heated. Such friction inducing materials and/or mechanisms include silicone rubber, adhesives, and/or tapes applied to one or more surfaces of the substrate of the heating element systems. In various embodiments, the friction-inducing mechanisms may include “friction squares” comprising a piece of silicone rubber, for example, that is affixed via fasteners to a pipe-facing surface of the substrate.

### BRIEF DESCRIPTION OF THE DRAWINGS

FIG. 1 is a perspective view of one embodiment of an electric heating element system of the instant disclosure.

FIG. 2 is a top plan view of the electric heating element system of FIG. 1.

FIG. 3 is a top plan view of multiple electric heating element systems of the instant disclosure in a representative phase of fabrication.

FIG. 4 is a top plan view of multiple electric heating element systems of the instant disclosure in another representative phase of fabrication.

FIG. 5 is a partial detail top plan view of an electric heating element system of the instant disclosure in another representative phase of fabrication.

FIG. 6 is a top plan view of an electric heating element system of the instant disclosure in another representative phase of fabrication.

FIG. 7 is a partial detail perspective view of one embodiment of heating element of the instant disclosure.

FIGS. 8-12 are partial detail plan views of an electric heating element system of the instant disclosure in various representative phases of fabrication.

FIG. 13 is a partial detail plan view of another embodiment of an electric heating element system of the instant disclosure in a representative phase of fabrication.

FIG. 14 is a partial detail perspective view of the electric heating element system of FIG. 13 in another representative phase of fabrication.

FIG. 15 is a partial top plan view of an electric heating element system of the instant disclosure in a partial state of articulation prior to installation onto a pipe.

FIGS. 16-17 are perspective views of an electric heating element system of the instant disclosure installed onto a pipe.

FIGS. 18-21 are partial detail perspective views of the electric heating element system of FIGS. 16-17.

FIG. 22 is a partial perspective view of an electric heating element system of the instant disclosure installed onto a pipe and over and around an obstacle associated with the pipe.

FIG. 23 is a partial perspective view of an electric heating element system of the instant disclosure installed onto a pipe together with an insulating layer.

FIG. 24 is a screenshot taken of an electric heating element system of the instant disclosure installed on a pipe and while in use.

FIG. 25 is a perspective view of another embodiment of an electric heating element system of the instant disclosure.

FIG. 26 is a top plan view of the electric heating element system of FIG. 25.

FIG. 27 is a top plan view of the electric heating element system of FIG. 25 in a representative phase of fabrication.

FIG. 28 is a perspective view of another embodiment of an electric heating element system of the instant disclosure.

FIG. 29 is a top plan view of the electric heating element system of FIG. 28.

FIG. 30 is a top plan view of the electric heating element system of FIG. 28 in a representative phase of fabrication.

FIG. 31 is a perspective view of another embodiment of an electric heating element system of the instant disclosure.

FIG. 32 is a top plan view of the electric heating element system of FIG. 31.

FIG. 33 is a top plan view of the electric heating element system of FIG. 31 in a

representative phase of fabrication.

FIG. 34 is a perspective view of another embodiment of an electric heating element system of the instant disclosure.

FIG. 35 is a top plan view of the electric heating element system of FIG. 34.

FIG. 36 is a top plan view of the electric heating element system of FIG. 34 in a representative phase of fabrication.

FIG. 37A is a perspective view of another embodiment of an electric heating element system of the instant disclosure.

FIG. 37B is another perspective view of the embodiment of an electric heating element system of FIG. 37A.

FIG. 38 is detail cross sectional view of a portion of the electric heating element system of FIG. 37A.

FIG. 39 is a listing of at least some of the types of electric heating elements that are suitable for adaptation in accordance with the teachings of the instant disclosure.

FIG. 40 is a graph of empirical data of an exemplary electric heating element system of the instant disclosure reflecting a simplified method for predicting the maximum extended length of the electric heating element system as a function of pipe diameter.

### DETAILED DESCRIPTION

Although the figures and the instant disclosure describe one or more embodiments of an electric heating element system, one of ordinary skill in the art would appreciate that the teachings of the instant disclosure would not be limited to these embodiments. It should be appreciated that any of the features of an embodiment discussed with reference to the figures herein may be combined with or substituted for features discussed in connection with other embodiments in this disclosure.

Various embodiments of electric heating element systems to heat pipes are disclosed herein. Electric heating element systems of the instant disclosure enable easy and effortless installation onto pipes located, for example, inside or outside a commercial/industrial building. Such pipes may contain bends or obstructions, such as unistruts, hangers, T-offs, and pipe flanges, the heating element systems of the instant disclosure are able to easily install over such bends or obstructions. More particularly, various embodiments of a heating element system disclosed herein enable installation onto a length of pipe without having to spirally wrap the heating element around the pipe and without having to calculate the spiraled length of wound heating element to heat a desired length of pipe. Instead, various embodiments of heating element systems of the instant disclosure can be unrolled or simply laid upon the pipe longitudinally if already unrolled, then circumferentially wrapped around the pipe, and snapped or fastened to itself or to anchors positioned at points along the pipe to enclose a desired pipe perimeter and length of pipe with enough heating element of a given wattage per foot to provide the desired amount of heat to the peripheral surface area of the pipe.

The installed length of the electric heating element systems of the instant disclosure on a given pipe is user-customizable at the time of installation due to possessing features that enable linear extension and retraction of the heating element system. In other words, the length of the electric heating element systems of the instant disclosure may vary to any desired amount. For example, to extend and/or install over a length of pipe, various embodiments of heating element systems of the instant disclosure enable linear extension of the heating element system so as to linearly expand and/or extend up to 80% longer or more than its pre-extended length.

Over long pipe lengths, multiple units of heating element systems of the instant disclosure may be positioned in series on the pipe to be heated. In this way, users may order multiple units of the heating element system to cover a desired overall linear length of pipe while rounding down to the nearest multiple of the pre-extended heating element system length.

In addition to substantially improving the ease with which a user can estimate the length of heating element of a given wattage per foot needed to heat a given length of pipe as well as the ease of installation of a heating element system on the pipe, various embodiments of a heating element system of the instant disclosure enable substantially improved heat distribution along and around the surface of the pipe to minimize and/or eliminate impermissibly cold or cooler spots, sections, or areas on the pipe. To do that, various embodiments of the heating element systems of the instant disclosure may include a heating element that is arranged in a serpentine manner on a two-dimensional, heat resistant substrate. The two-dimensional substrate may be flexible so as to wrap around the circumference of the pipe. After longitudinally extending the heating element system along the pipe to a desired extended length and then circumferentially wrapping the heating element system around the pipe, the serpentine arrangement of the heating element upon the substrate is configured to serpentine along the length of the pipe, thereby covering the outer surface of the pipe along the length of the pipe with three-dimensional, serpentine patterns that define three-dimensional quadrilateral and/or diamond-shaped areas that are indirectly heated. A user may customize the size of those three-dimensional quadrilateral and/or diamond-shaped areas, and therefore the amount of pipe surface area that is directly exposed to heat from the heating element, by adjusting the extent to which the heating element system is extended from its original unextended length. In other words, the greater the amount of linear extension of the heating element system upon a pipe, the larger the area defined by the three-dimensional quadrilateral and/or diamond-shaped areas and vice-versa. In some embodiments, the three-dimensional quadrilateral and/or diamond-shaped areas include rhomboids. Likewise, as the amount of linear extension of the heating element system increases along a pipe, then the serpentined passes or turns become less acute, which may cause less surface area of the pipe to be directly exposed to heat from the heating element and vice versa. But being able to customize the installed length of heating element systems of the instant disclosure as needed provides the advantage of using a single dimensional and operational configuration of heating element (i.e., watts per foot and length) and substrate (length×width) on a wide range of pipe diameters and pipe lengths, while also improving heat distribution, all without having to change to a different size or heat output, thereby minimizing inventory of different sizes and heat output combinations.

To further enhance pipe heating performance, heating element systems of the instant disclosure may include an insulating blanket that may be installed over and around the heating element system. The insulating blanket may be configured to contain emitted heat from the heating element within the immediate zone of the pipe and to reduce heat loss to the environment. The insulating blanket may further assist the functionality of the heating element system by encouraging emitted heat from the heating element to migrate to the three-dimensional quadrilateral and/or diamond-shaped areas to heat those areas of the pipe.

During use when the heating element is energized with electric current, the serpentine heating element emits heat energy due to the electrical resistance and material properties of the resistance wire disposed therein, and that heat energy migrates by conduction, radiation, and convention to various portions of the pipe outer wall. Areas of the pipe in direct contact with the heating element/substrate will initially be exposed to the highest available temperatures emitted by the heating element of the heating element system, whereas open areas defined by the three-dimensional serpentines of the heating element will receive heat that migrates from the heating element to those areas.

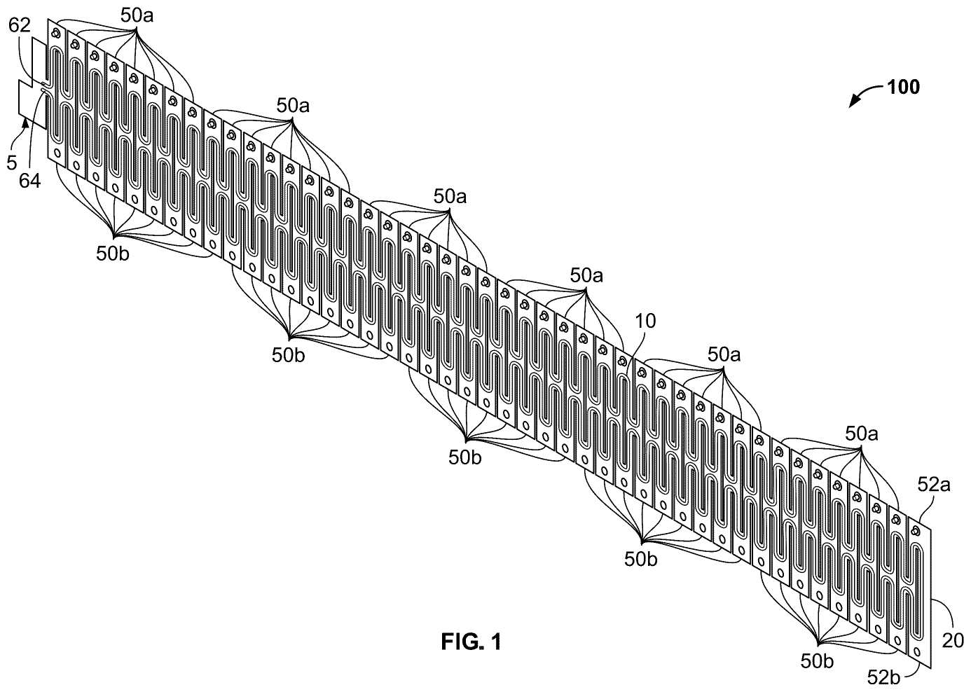

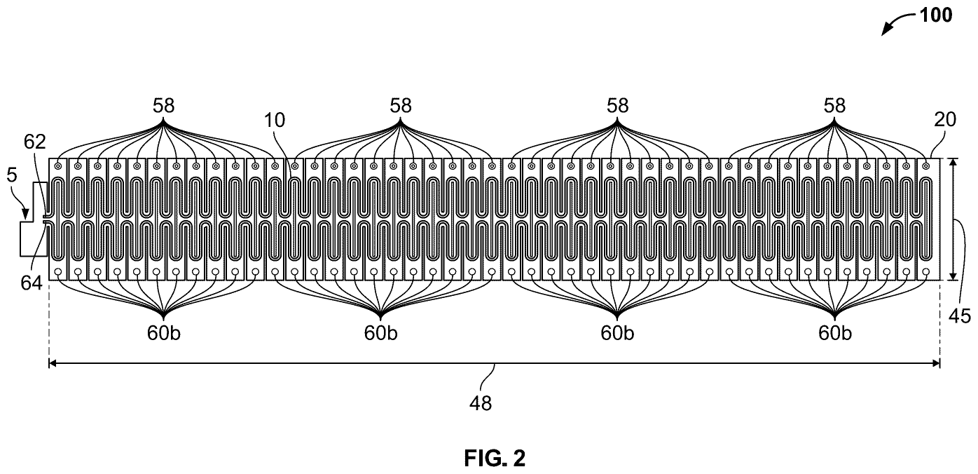

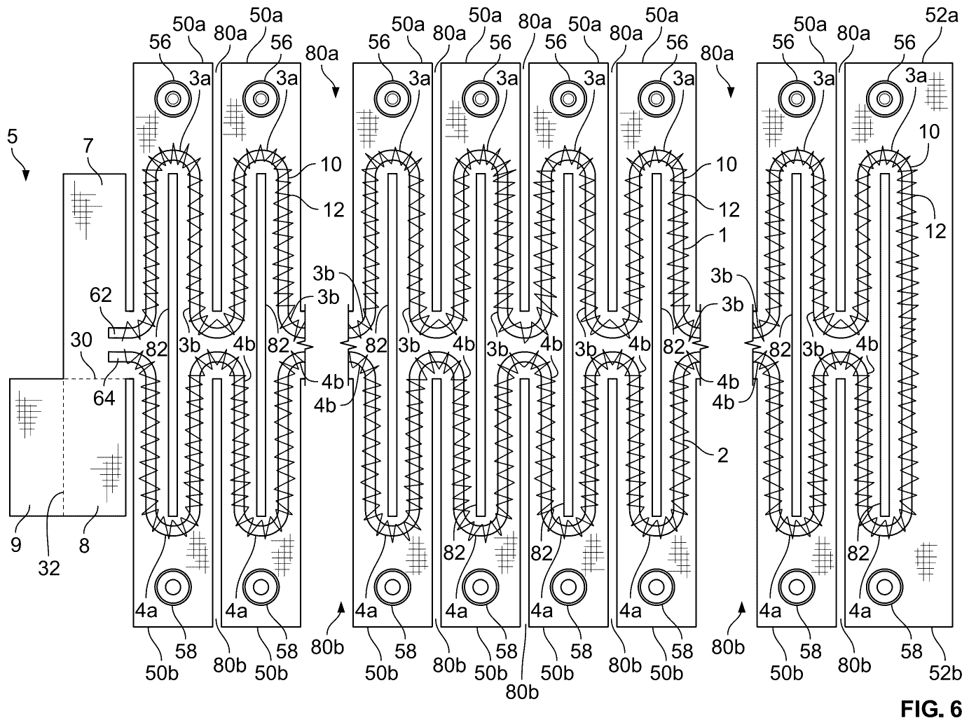

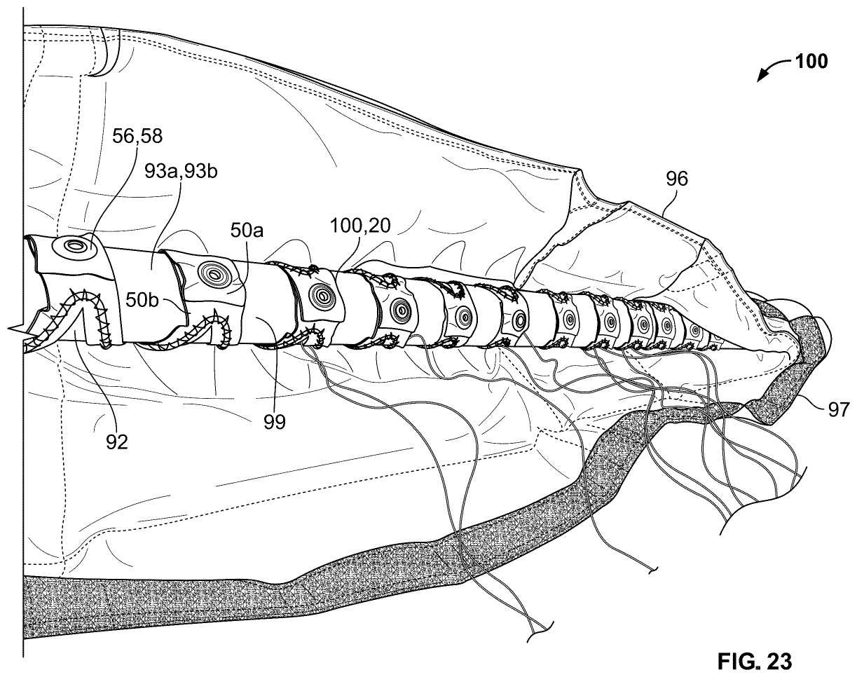

Turning now to the drawings and to FIGS. 1-2 in particular, there is shown a portion of one embodiment of an electric heating element system 100 for heating pipes. FIG. 1 shows system 100 in perspective while FIG. 2 shows a plan view of system 100. System 100 includes heating element 10 secured to substrate 20 and a terminal end 5 for connecting heating element 10 to electrical power via a pair of lead wires 65,67. As shown in FIG. 23, heating element system 100 may include an insulating blanket 96 applied over and circumferentially around heating element system 100 and pipe 99 upon which heating element system 100 is installed to aid heat distribution to the surface of the pipe. Heating element 10 is arranged on substrate 20 in a serpentine pattern, where respective portions 1,2 of heating element 10 are positioned in a pair of serpentine rows immediately adjacent one another, one above the other as shown in FIG. 2, for example, and in a continuous loop to cause both conductor ends 62,64 of heating element 10 to lie at or near terminal end 5. In this embodiment, as shown in FIG. 6, each serpentine pass or turn 3a,3b of portion 1 of heating element 10 is in symmetry with each serpentine pass or turn 4a,4b of portion 2 of heating element 10 about an imaginary centerline that longitudinally bisects substrate 20. Heating element 10 may be secured to substrate 20 via stitches 12, which may allow for an amount of movement of heating element 10 relative to substrate 20 to allow flexibility and articulation of heating element system 100 for ease of installation onto a pipe. In other embodiments, spaced apart clamps, tie wraps, hooked clips, rings and belt, belt and buckles, lace and speed hooks (as typically found on boots), or any other suitable fastening means may be employed to secure heating element 10 to substrate 20.

As best shown in FIG. 6, substrate 20 includes a plurality of transverse, spaced apart slots 80a,80b. Slots 80a begin at an outer longitudinal peripheral edge of substrate 20 and extend vertically (if substrate 20 is in the orientation shown in FIG. 6) toward the centerline. Slots 80b begin at an outer longitudinal peripheral edge of substrate 20 and extend vertically (if substrate 20 is in the orientation shown in FIG. 6) toward the centerline and laterally inline with the lateral positions of each of slots 80a. Thus, in this embodiment, slots 80a and 80b are in symmetrical orientation with one another about the imaginary longitudinal centerline of substrate 20. The position and transverse length of slots 80a,80b define a plurality of fastener ends 50a,50b and end tabs 52a,52b of substrate 20. It should be understood that the vertical length of slots 80a,80b may be longer or shorter without departing from the scope of the instant disclosure. In addition, in some embodiments, slots 80a may be offset from slots 80b. In such embodiments, the serpentine pattern of heating element 10 may be different from that shown in the figures without departing from the scope of the instant disclosure.

Substrate 20 also includes a plurality of transverse slots 82 that are spaced apart from one another and from slots 80a,80b. Slots 82 are positioned between respective slots 80a,80b such that the lateral spacing between slots 80a,80b and slots 82 are approximately the same. Slots 82 straddle the imaginary longitudinal centerline of substrate 20 and extend in opposite directions, both upwardly and downwardly from the centerline (as viewed in FIG. 6). Heating element 10 is configured to be positioned on substrate 20 by routing and securing heating element 20 thereto and around each of the slots 80a,80b,82 in a serpentine manner. It should be understood that the vertical length of slots 82 may be longer or shorter without departing from the scope of the instant disclosure. As will be discussed more fully below and as shown in the figures, slots 80a,80b and 82 may be sized and positioned to enable substrate 20 to extend longitudinally over a length of pipe 99 from a first, unextended length up to a second, extended length and to enable easy navigation over and around obstacles associated with the pipe 99 without compromising heat distribution to the pipe 99.

As best shown in FIG. 6, substrate 20 includes a plurality of fastener portions 56,58. Each of the fastener portions 56,58 are positioned at respective fastener apertures 60a,60b on respective fastener ends 50a,50b and end tab 52a,52b of substrate 20. Respective fastener portions 58 may be configured to securely yet removably receive respective fastener portions 56. Fastener portions 58 may include a receiver for receiving an engager of each of the fastener portions 56. In other embodiments, fastener portions 56 may include a receiver for receiving an engager of each of the fastener portions 58. In one embodiment, fastener portions 56,58 include snap fasteners of durable, temperature-resistant plastic or metallic materials to easily and securely, yet removably, install heating element system 100 onto and around a pipe 99. In other embodiments, heating element system 100 may be configured with different fastener systems, such as hook and loop fasteners, spring clips, high strength magnets (such as the rare Earth type), or any other common fastening system suitable for heated temperature environments consistent with the instant disclosure.

Substrate 20 may be at least partially or fully flexible to enable easy positioning and fastening of heating element system 100 onto a pipe 99. In various embodiments, substrate 20 comprises a heat resistant material, such as a PTFE coated fiberglass cloth or fabric, an ePTFE cloth or fabric, a PTFE laminate film, a polyamide film, a fiberglass paper, a silicone coated fiberglass, a raw silicone sheet, a fiberglass bonded raw silicone sheet, a nonwoven polymer cloth, a fiberglass mesh, a nonwoven fabric, or a rubber sheet. Suitable thin films include temperature resistant, non-elastic polymeric sheets of less that 1/16″ thick. In one embodiment, substrate 20 is configured to be installed on a 1.5″ diameter pipe. In other embodiments, substrate 20 may be sized and/or configured to install onto any pipe 99 having an outer diameter from 0.25″ to 15″. For example, height 45 of substrate 20 may be configured to enable vertical positioning of respective fastener portions 56 relative to corresponding fastener portions 58 to approximate the outer circumference of the pipe 99 on which heating element system 100 may be installed. Likewise, length 48 of substrate 20 may be configured to be approximately 47″ long in its unextended length, and approximately 84″ in its fully extended length. In other embodiments, length 48 of substrate 20 may be any desired length. Large diameter pipes may require longer lengths of heater element 10 to prevent or minimize watt density from dropping below a desired level.

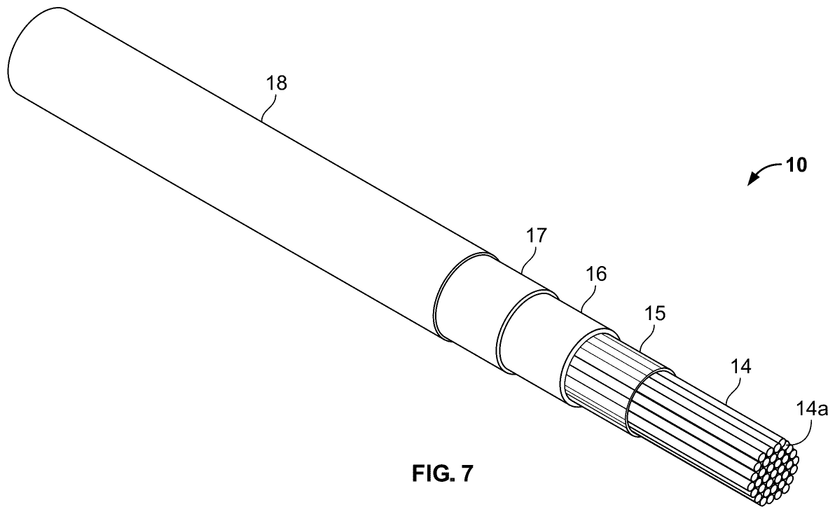

Turning to FIG. 7, there is shown a representative heating element 10 for use in heating element systems 100 of the instant disclosure. In some embodiments, heating element 10 may include the class of self-regulating heating elements, and may include resistance wire 14, sleeve 15, insulation layers 16,17, and ground layer 18. In this embodiment, resistance wire 14 comprises a plurality of strands 14a of 37 gauge (approx. 0.0045 dia.) alloy 180 comprising a nickel copper alloy, each strand configured for 8.88 ohms +/−8% per foot. In this embodiment, sleeve 15 comprises Kapton, layers 16,17 both comprise fiberglass, and ground layer 18 comprises a 36 gauge braid of tinned copper material. In this embodiment, heating element 10 may be 104 ft long, 0.0625 dia. and is rated at 120 VAC and 1.34 watts per foot for a total of 139.8 watts for that length. A heating element 10 of this construction may be set at 180° C. to deliver heat to a pipe 99 about which heating element system 100 is installed. A heating element of this configuration is available from BriskHeat Corporation of Columbus, OH. Other embodiments of heating element system 100 may include any heating element of suitable construction without departing from the scope of the instant disclosure. For example, other heating element 10 configurations suitable for use in heating element system 100 of the instant disclosure may include a single, solid core of resistance wire 14 instead of multiple strands as shown in FIG. 7. Likewise, heating element 10 may include different insulation layers, such as layers comprising TFE, PTFE, ePTFE, and stainless steel thread.

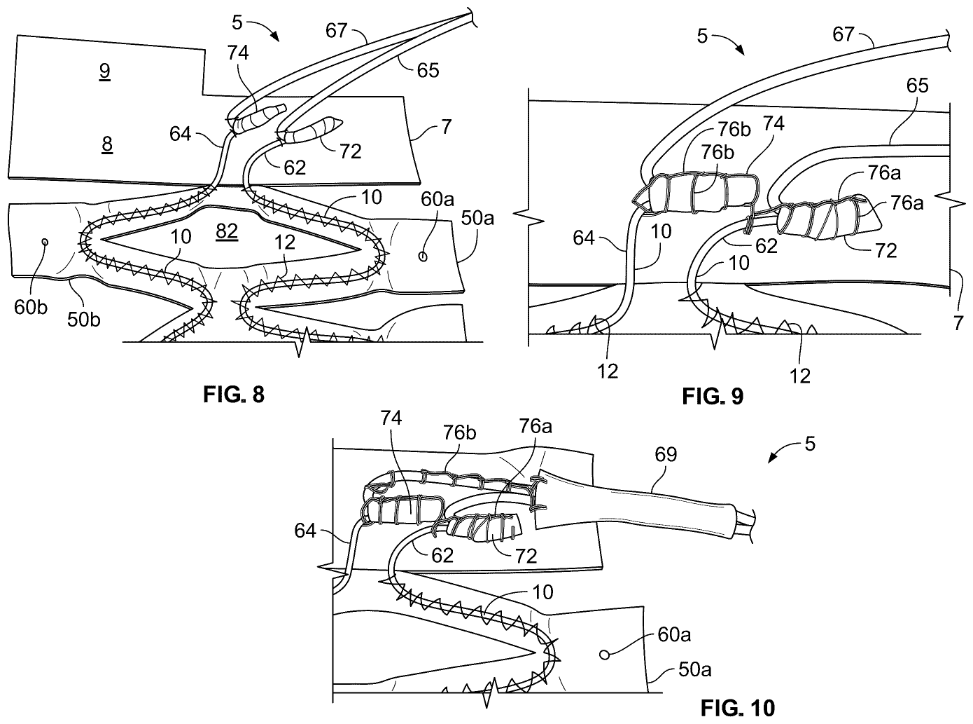

Turning to FIGS. 8-14, there are shown various stages and embodiments of coupling conductor ends 62,64 of heating element 10 to an electrical power source. As discussed above, heating element 10 is a continuous element that is secured to substrate 20 and routed around each of slots 80a,80b,82 such that both conductor ends 62,64 meet together at or near terminal end 5 of heating element system 100. Substrate 20 includes tabs 7,8 and flap 9 for housing and/or enclosing conductor junctions 72,74 of heating element 10. Conductor junctions 72,74 enclose electrical conductor connections between lead wires 62,64 and conductor ends 62,64 of heating element 10. As shown in FIGS. 9-10, conductor junctions 72,74 may be stitched or otherwise secured to substrate 20 via stitches 76a,76b. Lead wires 62,64 exiting conductor junctions may additionally be housed in sleeve 69 for abrasion and heat resistance.

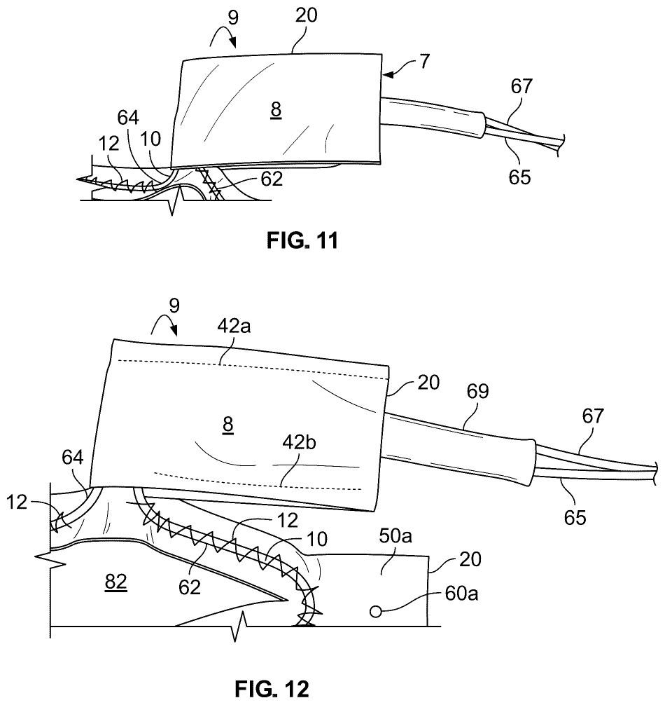

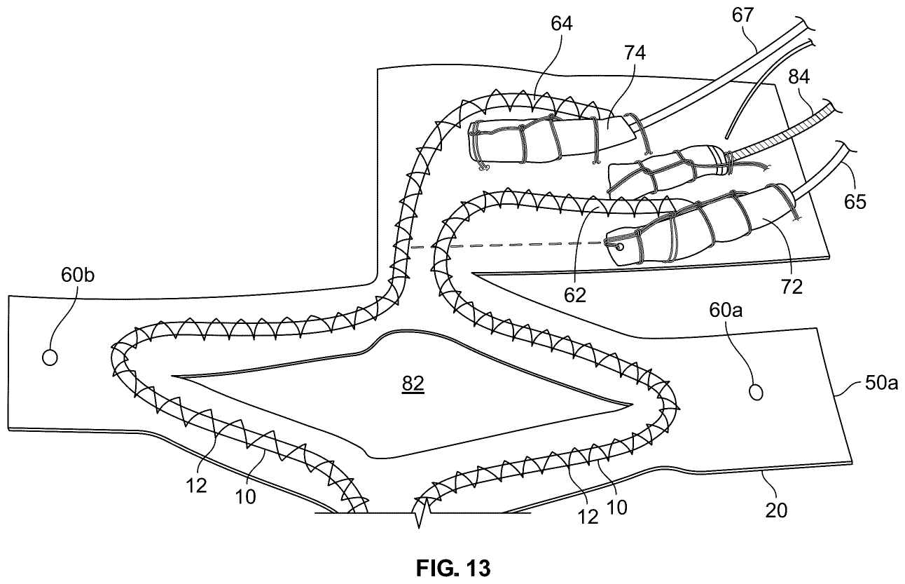

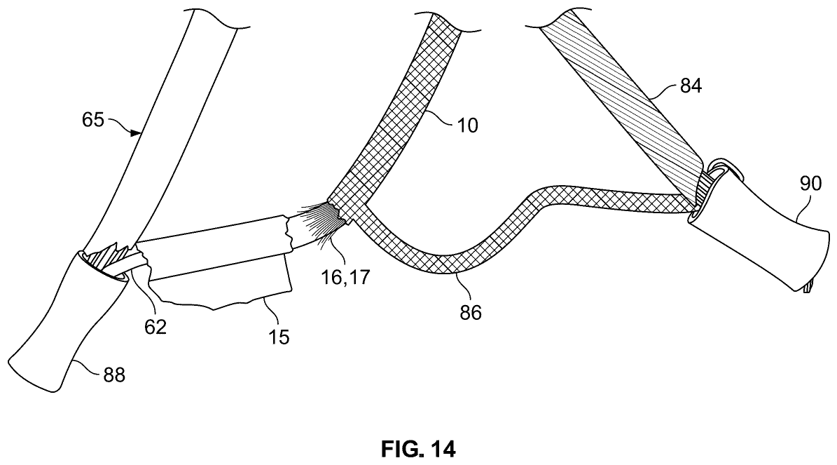

FIGS. 11-12 show tab 7 after having been folded along fold line 30 to align with tab 8, and after flap 9 has been folder along fold line 32 to encase conductor junctions 72,74. Stitches 42a,42b may be configured to secure tab 7 to tab 8 and flap 9 to tab 7 and to encase conductor junctions 72,74. FIGS. 13-14 show an embodiment of heating element 10 incorporating ground wire 84. In this embodiment, outer ground layer 18 is partially stripped from a portion of conductor end 62 of heating element 10 and connected to ground wire 84 via crimp connector 90 while conductor end 62 of heating element 10 is connected to lead wire 65 via crimp connector 88.

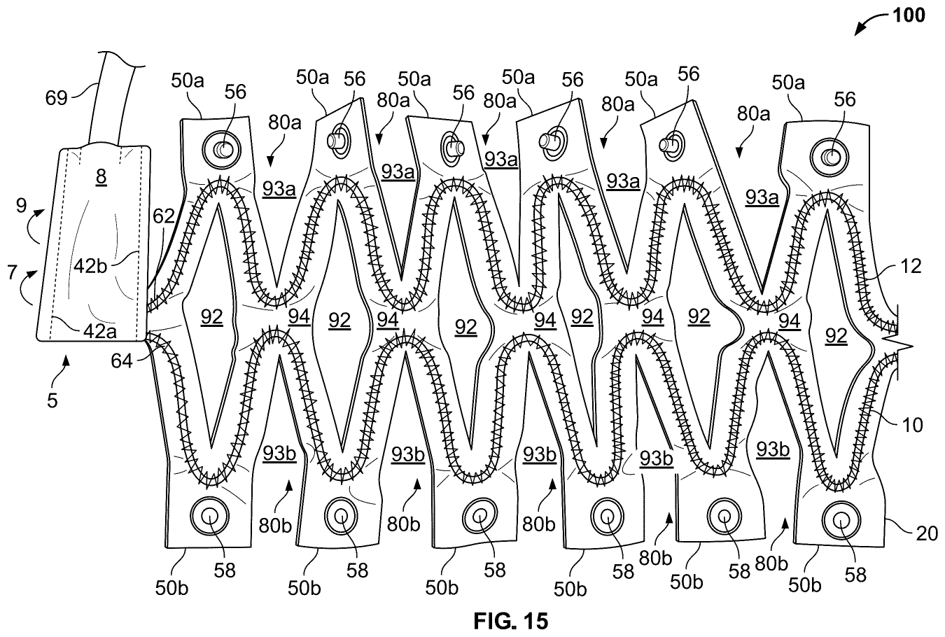

Turning to FIG. 15 there is shown a partially extended and/or articulated heating element system 100 of the instant disclosure. FIG. 15 shows how slots 80a,80b,82 together define alternating spaced apart, elongated apertures 92, alternating spaced apart webbing 94, and alternating, elongated apertures 93a,93b in substrate 20 when heating element system 100 is at least partially extended in a longitudinal direction. FIG. 15 also shows how heating element 10 may be routed in a serpentine arrangement around slots 80a,80b,82 in two adjacent rows that mirror one another about a longitudinal centerline of substrate 20. FIG. 15 further illustrates the flexibility of substrate 20 and the potential ease with which fastener ends 50a,50b may be brought together around a circumference of a pipe 99.

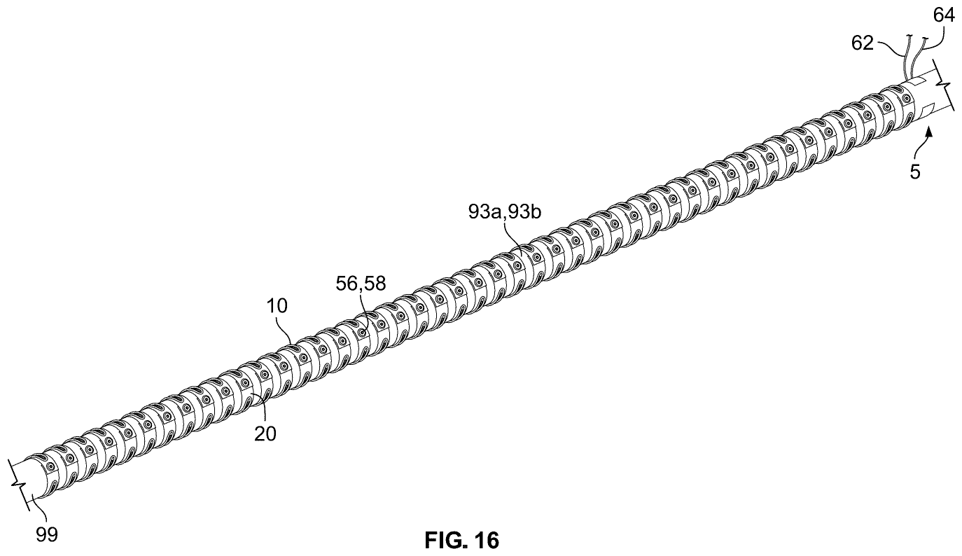

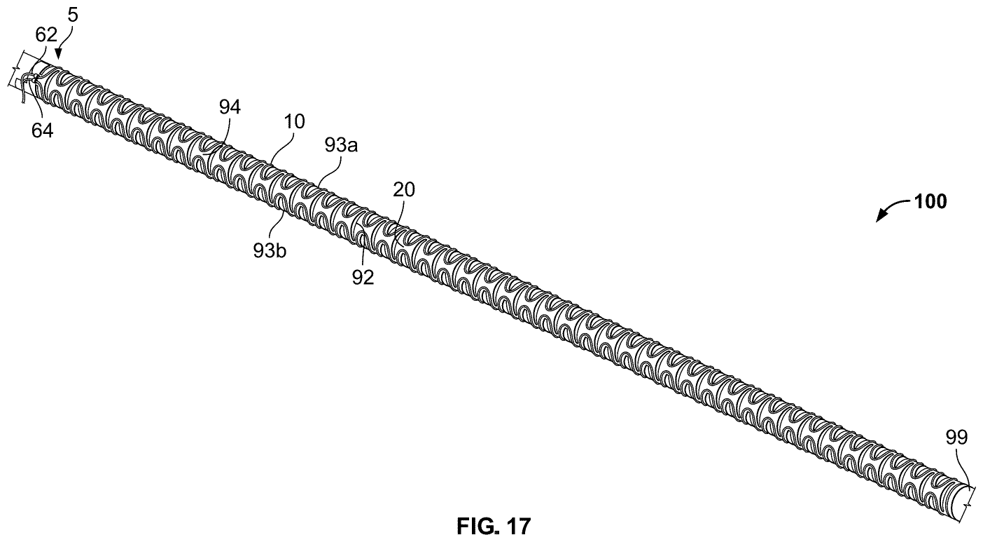

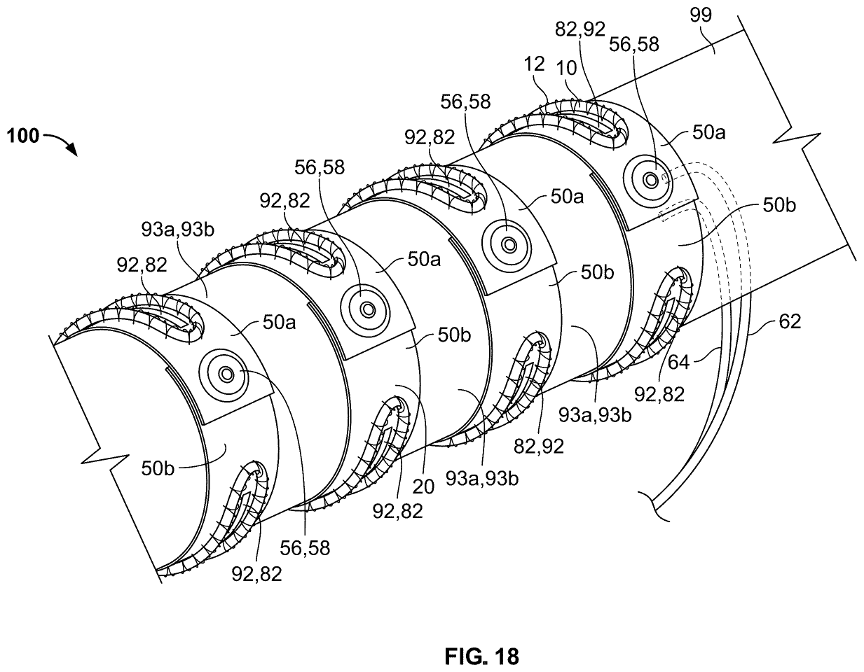

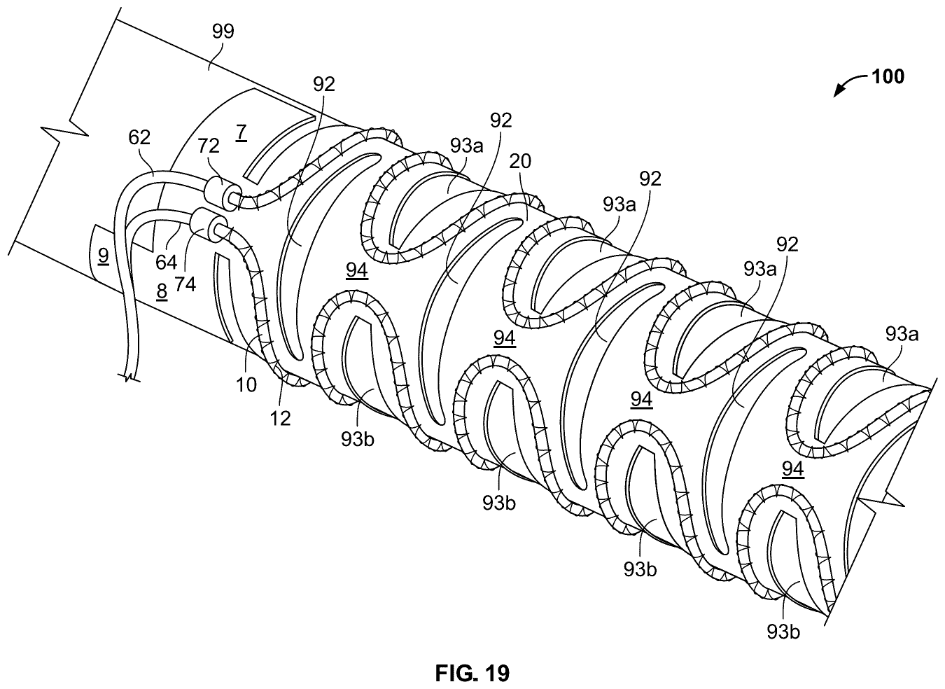

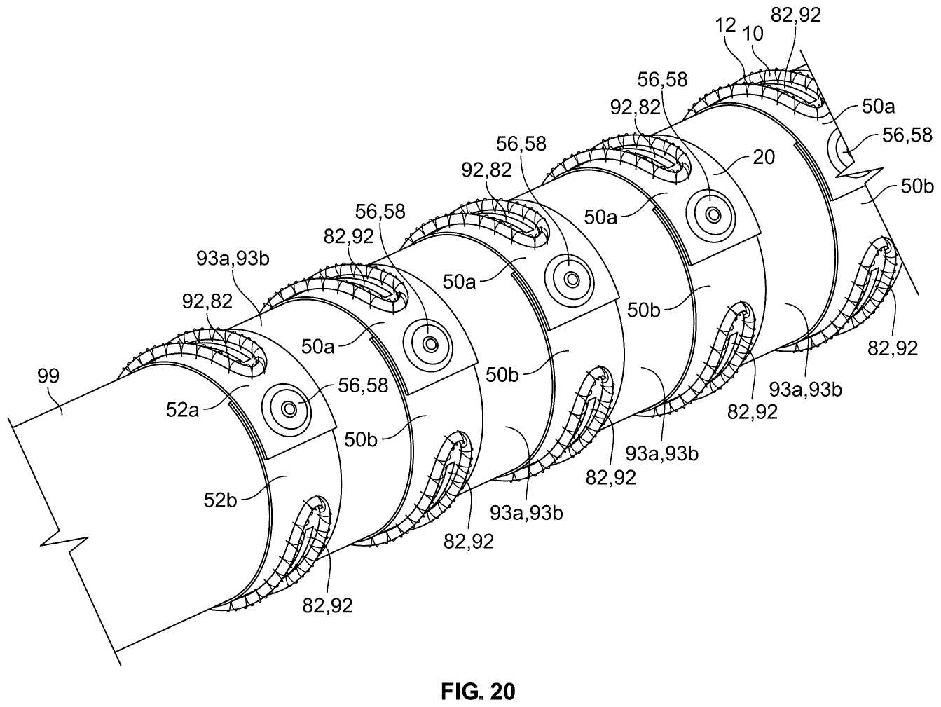

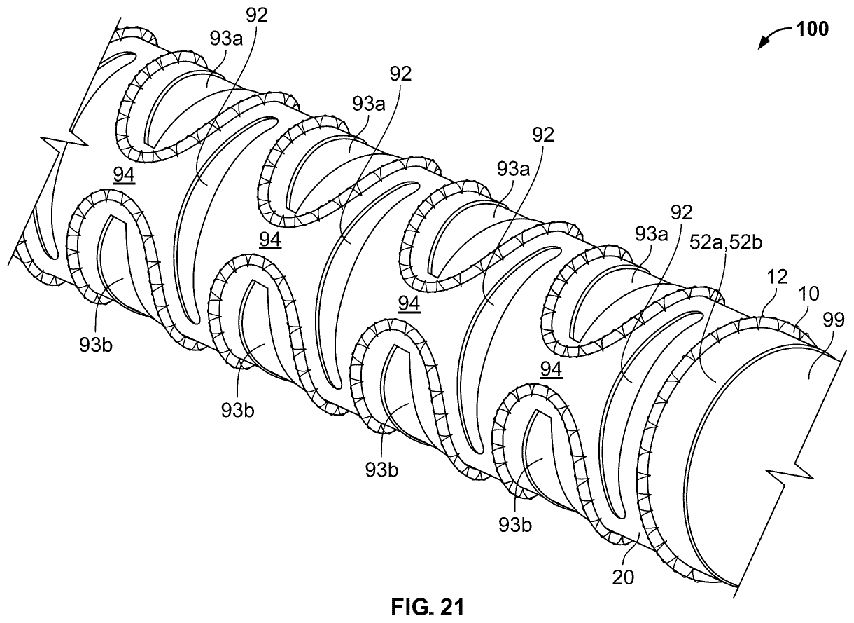

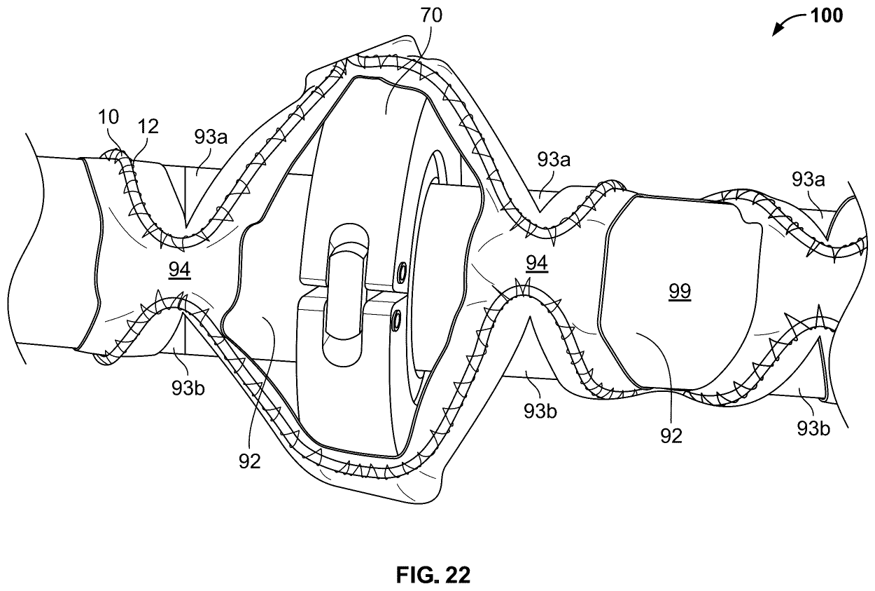

FIGS. 16-23 illustrate various aspects of heating element system 100 installed on an exemplary pipe 99. As shown in these figures, heating element system 100 is extended along a length of the pipe 99 in accordion fashion to a desired extent while fastener ends 50a,50b and end tabs 52a,52b of substrate 20 are brought together around the circumference of the pipe 99 and fastened together using fastener portions 56,58. Although the available watts per foot of a given heating element 10 is fixed, a user may still customize the amount of heat applied to the pipe 99 and the heat distribution between adjacent turns of heating element 10 on substrate 20 by extending or contracting the heating element 10 along the length of the pipe 99. FIG. 22 illustrates how embodiments of heating element systems 100 of the instant disclosure are adjustable to extend over and around an obstacle 70. FIG. 23 illustrates an embodiment of heating element system 100 (with optional thermocouples) comprising insulating blanket 96 positioned over and around pipe 99 to further aid heat distribution to pipe 99 and to minimize heat loss. Insulating blanket 96 may be secured to itself and around pipe 99 using fastener 97, which may comprise, for example, a hook and loop fastener or any other fastening system.

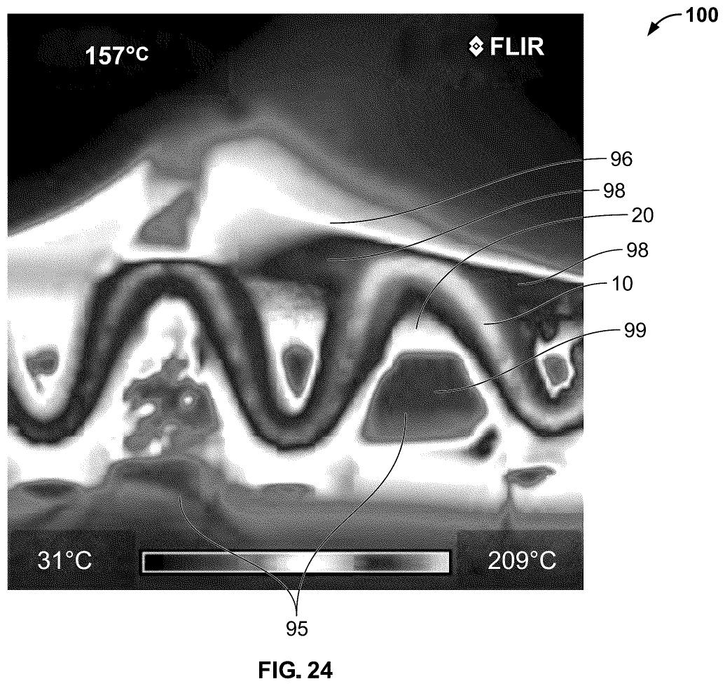

FIG. 24 is a temperature distribution screenshot taken by a thermal imaging camera of an exemplary heating element system 100 and the area of pipe 99 in proximity to heating element system 100 while in use. Insulating blanket 96 is disposed over and around pipe 99 but is partially peeled away from the bottom, sides, and upper left portion of horizontal pipe 99 to enable the camera to capture this image. The image reveals that the hottest temperature exists in the center of heating element 10, and the next hottest temperature exists in zones 98, which lie in proximity to insulating blanket 96 along the upper right of the image. By contrast, the coolest temperatures exist in zones 95, which lie primarily along the bottom of pipe 99 and between respective passes or turns of heating element 10. Empirical temperature measurements suggest that the temperature distribution along the length of pipe 99 and around the entire circumference of pipe 99 is more evenly distributed along the surface of pipe 99 when insulating blanket 96 is installed over and around pipe 99.

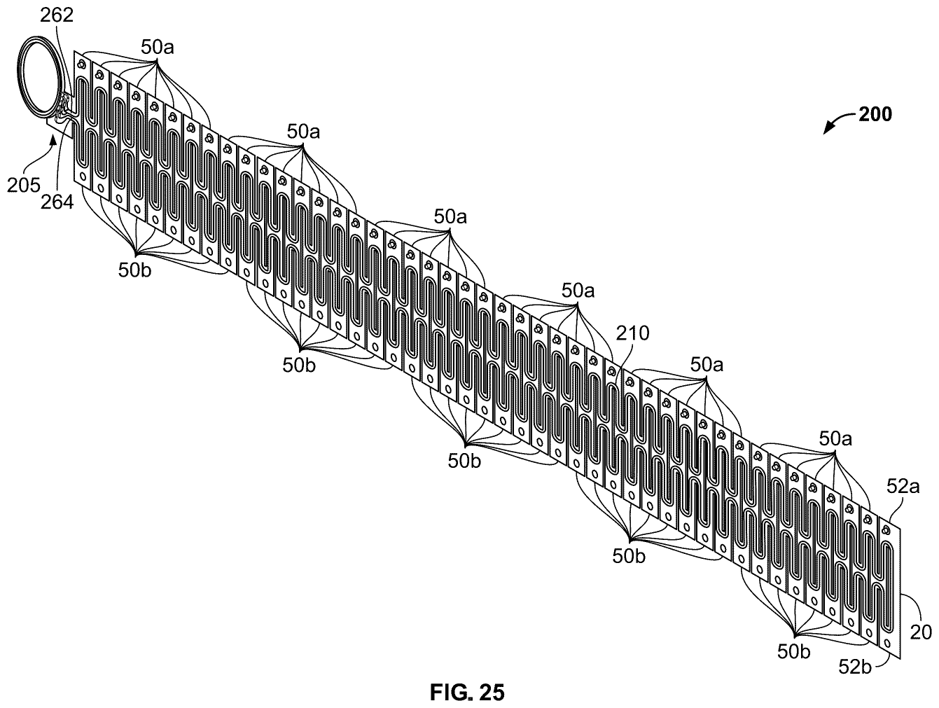

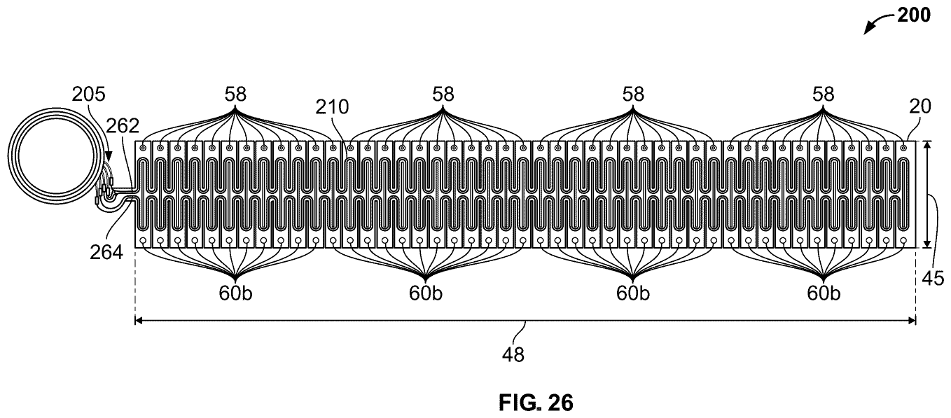

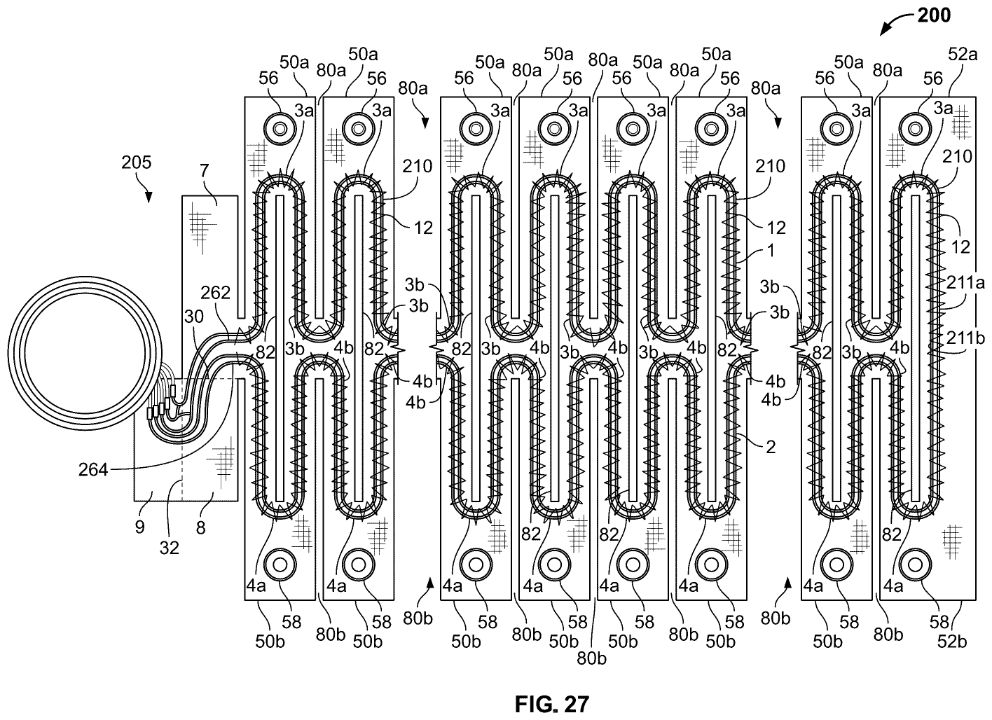

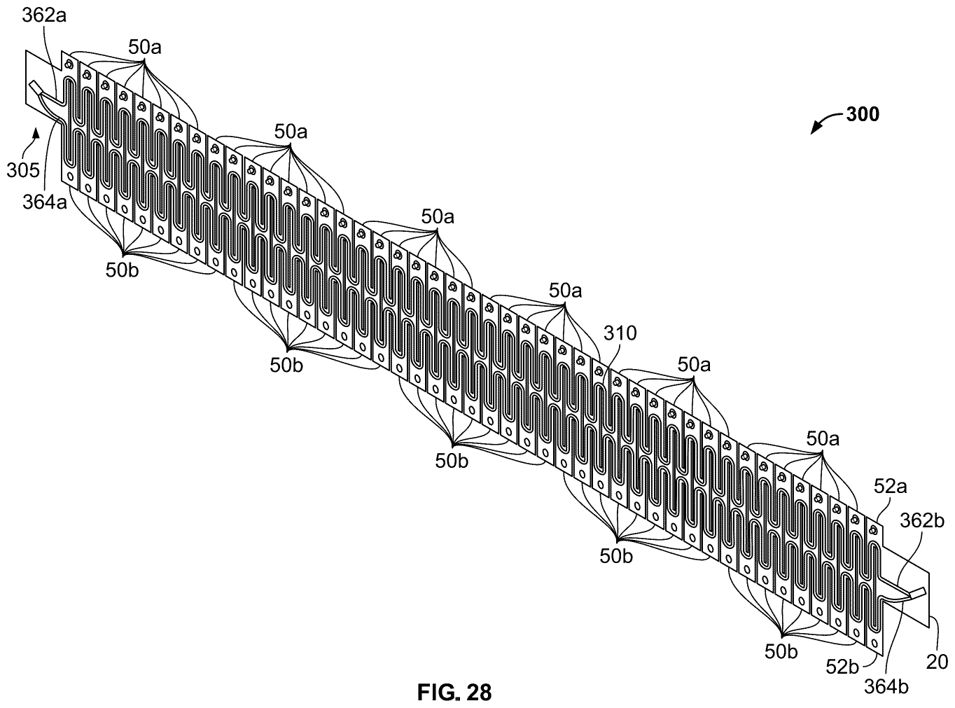

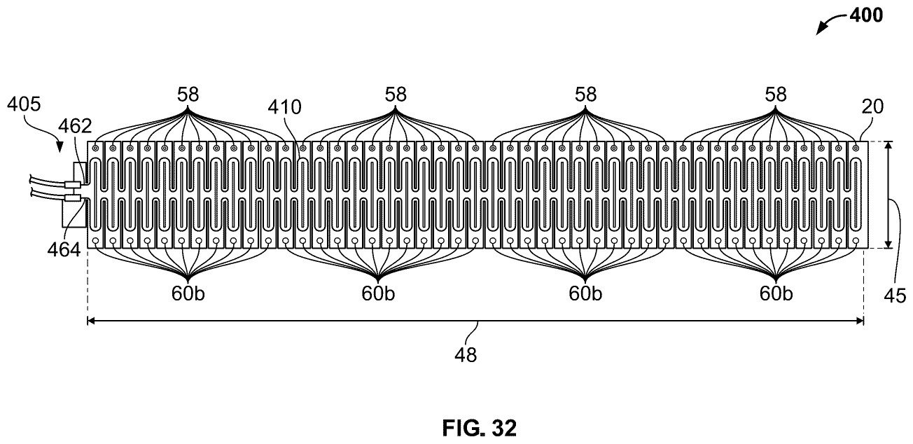

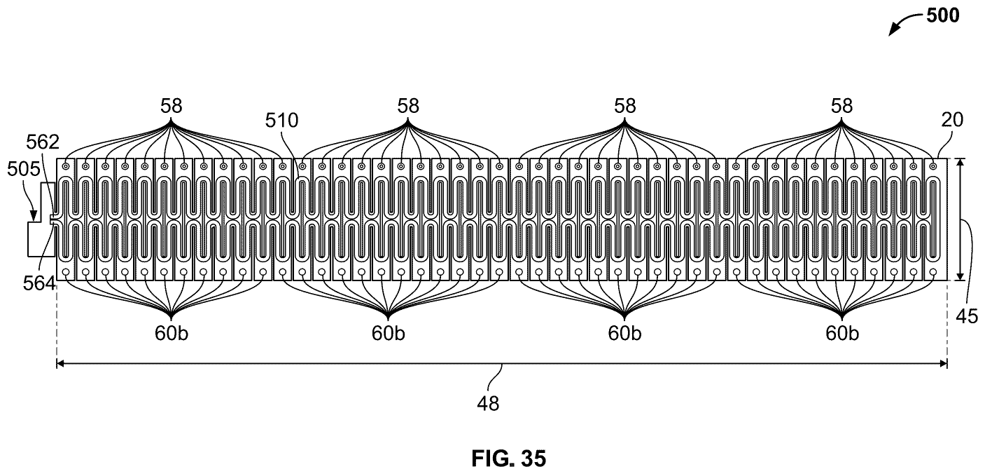

FIGS. 25-38 show alternative embodiments of an electric heating element system of the instant disclosure. For example, FIGS. 25-28 show electric heating element system 200 comprising parallel wire-type electric heating element 210 adapted for use in accordance with the teachings of the instant disclosure. Use of a parallel wire-type electric heating element 210 may allow a lower range of electrical resistances and higher wattages without increased electrical safety risks. System 200 includes heating element 210 secured to substrate 20 and a terminal end 205 for connecting heating element 210 to electrical power via a pair of lead wires 65,67. As shown in FIG. 23, heating element system 200 may include an insulating blanket 96 applied over and circumferentially around heating element system 200 and pipe 99 upon which heating element system 200 is installed to aid heat distribution to the surface of the pipe. Heating element 210 is arranged on substrate 20 in a serpentine pattern, where respective portions 1,2 of heating element 210 are positioned in a pair of serpentine rows immediately adjacent one another, one above the other as shown in FIG. 27, for example, and in a continuous loop to cause both conductor ends 262,264 of heating element 210 to lie at or near terminal end 205. In this embodiment, as shown in FIG. 27, each serpentine pass or turn 3a,3b of portion 1 of heating element 210 is in symmetry with each serpentine pass or turn 4a,4b of portion 2 of heating element 210 about an imaginary centerline that longitudinally bisects substrate 20. Heating element 210 may be secured to substrate 20 via stitches 12, which may allow for an amount of movement of heating element 210 relative to substrate 20 to allow flexibility and articulation of heating element system 200 for ease of installation onto a pipe. In other embodiments, spaced apart clamps, staples, tie wraps, hooked clips, rings and belt, belt and buckles, lace and speed hooks (as typically found on boots), or any other suitable fastening means may be employed to secure heating element 210 to substrate 20.

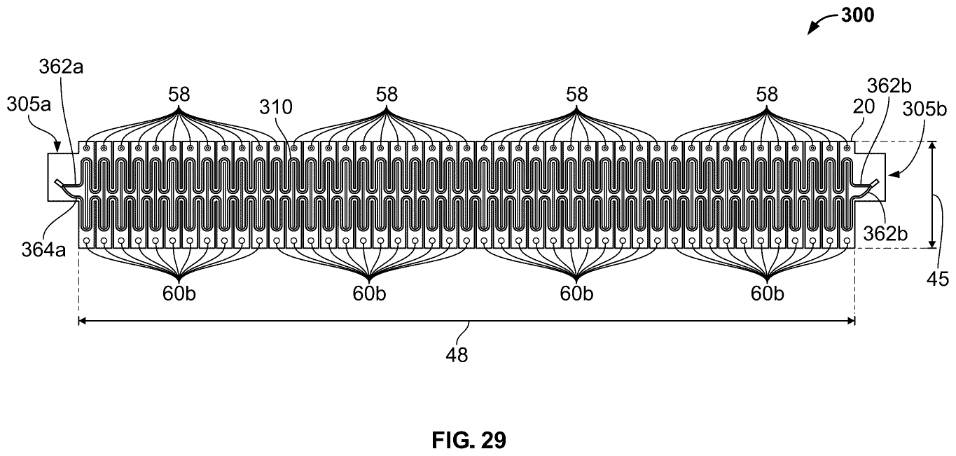

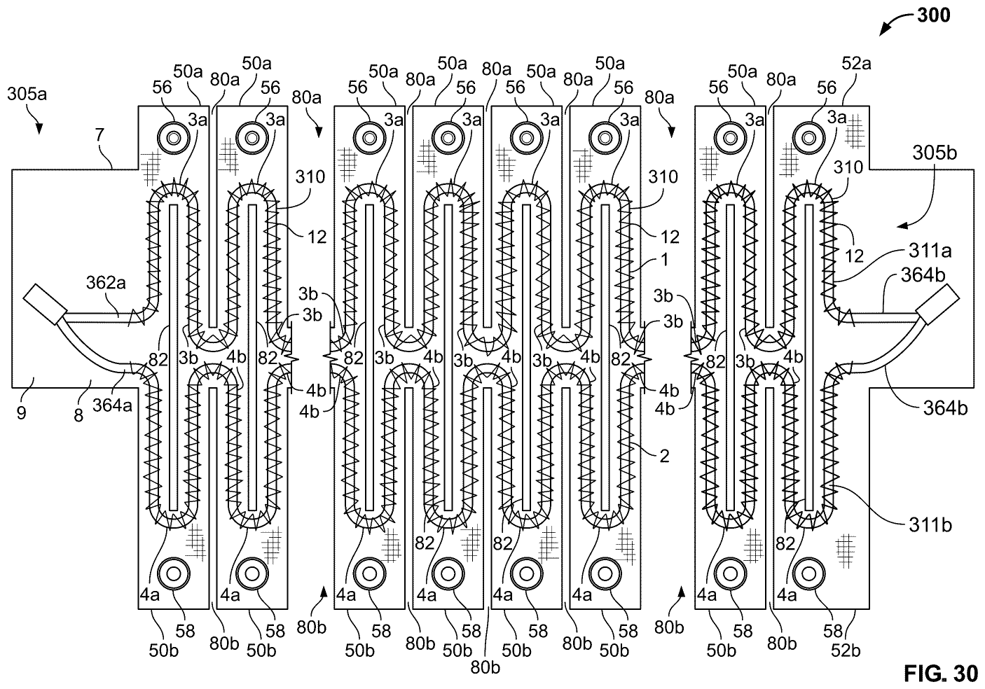

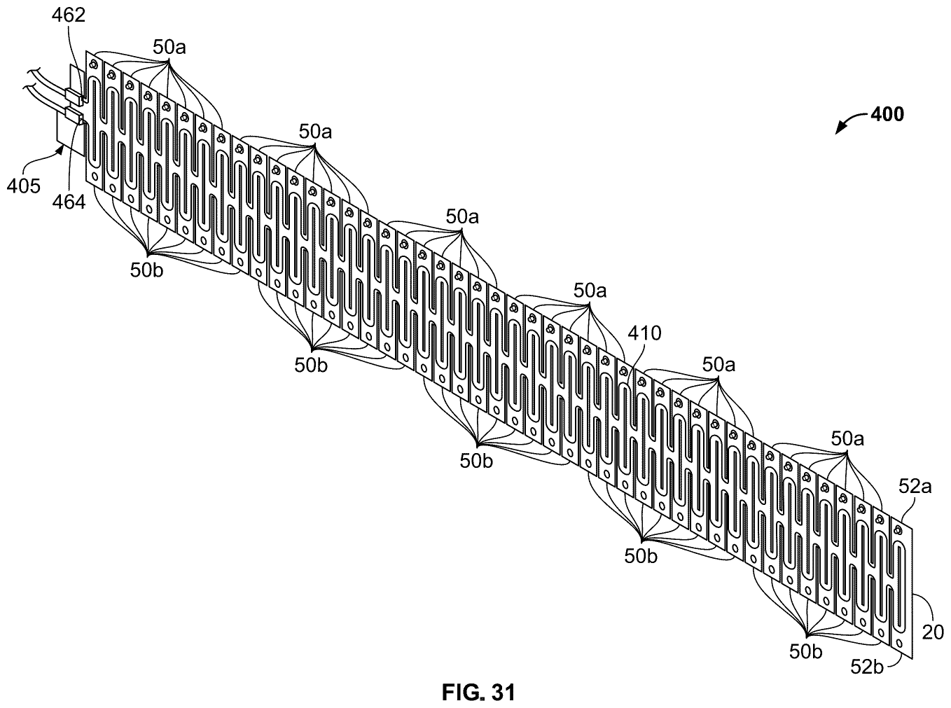

FIGS. 29-30 show electric heating element system 300 comprising electric heating element 310 adapted for use in accordance with the teachings of the instant disclosure. In this embodiment, the conductor ends 362a,364a and 362b,264b lie on opposite terminal ends 305a and 305b, respectively, to provide the ability to connect multiple electric heating element systems of the instant disclosure in series. System 300 includes heating element 310 secured to substrate 20 and terminal ends 305a and 305b for connecting heating element 310 to electrical power via a pair of lead wires 65,67 connected to each of the terminal ends 305a,305b. As shown in FIG. 23, heating element system 300 may include an insulating blanket 96 applied over and circumferentially around heating element system 300 and pipe 99 upon which heating element system 300 is installed to aid heat distribution to the surface of the pipe. Heating element 310 is arranged on substrate 20 in a serpentine pattern, where respective portions 1,2 of heating element 310 are positioned in a pair of serpentine rows immediately adjacent one another, one above the other as shown in FIG. 30, for example. In this embodiment, as shown in FIG. 30, each serpentine pass or turn 3a,3b of portion 1 of heating element 310 is in symmetry with each serpentine pass or turn 4a,4b of portion 2 of heating element 310 about an imaginary centerline that longitudinally bisects substrate 20. Heating element 310 may be secured to substrate 20 via stitches 12, which may allow for an amount of movement of heating element 310 relative to substrate 20 to allow flexibility and articulation of heating element system 300 for ease of installation onto a pipe. In other embodiments, spaced apart clamps, staples, tie wraps, hooked clips, rings and belt, belt and buckles, lace and speed hooks (as typically found on boots), or any other suitable fastening means may be employed to secure heating element 310 to substrate 20.

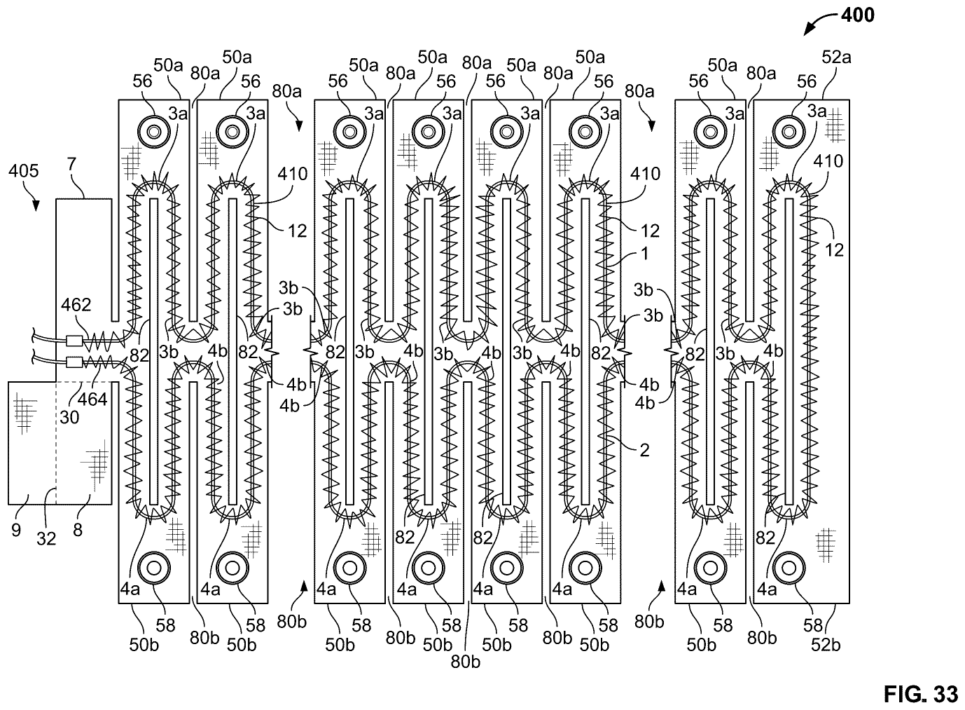

FIGS. 31-33 show electric heating element system 400 comprising heating ribbon or heat trace-type electric heating element 410 adapted for use in accordance with the teachings of the instant disclosure. System 400 includes heating element 410 secured to substrate 20 and a terminal end 405 for connecting heating element 410 to electrical power via a pair of lead wires 65,67. As shown in FIG. 23, heating element system 400 may include an insulating blanket 96 applied over and circumferentially around heating element system 400 and pipe 99 upon which heating element system 400 is installed to aid heat distribution to the surface of the pipe. Heating element 410 is arranged on substrate 20 in a serpentine pattern, where respective portions 1,2 of heating element 410 are positioned in a pair of serpentine rows immediately adjacent one another, one above the other as shown in FIG. 33, for example, and in a continuous loop to cause both conductor ends 462,464 of heating element 410 to lie at or near terminal end 405. In this embodiment, as shown in FIG. 33, each serpentine pass or turn 3a,3b of portion 1 of heating element 410 is in symmetry with each serpentine pass or turn 4a,4b of portion 2 of heating element 410 about an imaginary centerline that longitudinally bisects substrate 20. If heating element 410 is a heating ribbon-type electric heating element, then heating element 410 may be secured to substrate 20 via stitches 12 (which may allow for an amount of movement of heating element 410 relative to substrate 20 to allow flexibility and articulation of heating element system 400 for ease of installation onto a pipe) or otherwise laminated or adhered to substrate 20. If heating element 410 is a heat trace-type heating element, then heat trace-type heating element may be screen printed, deposited, or digitally printed on substrate 20.

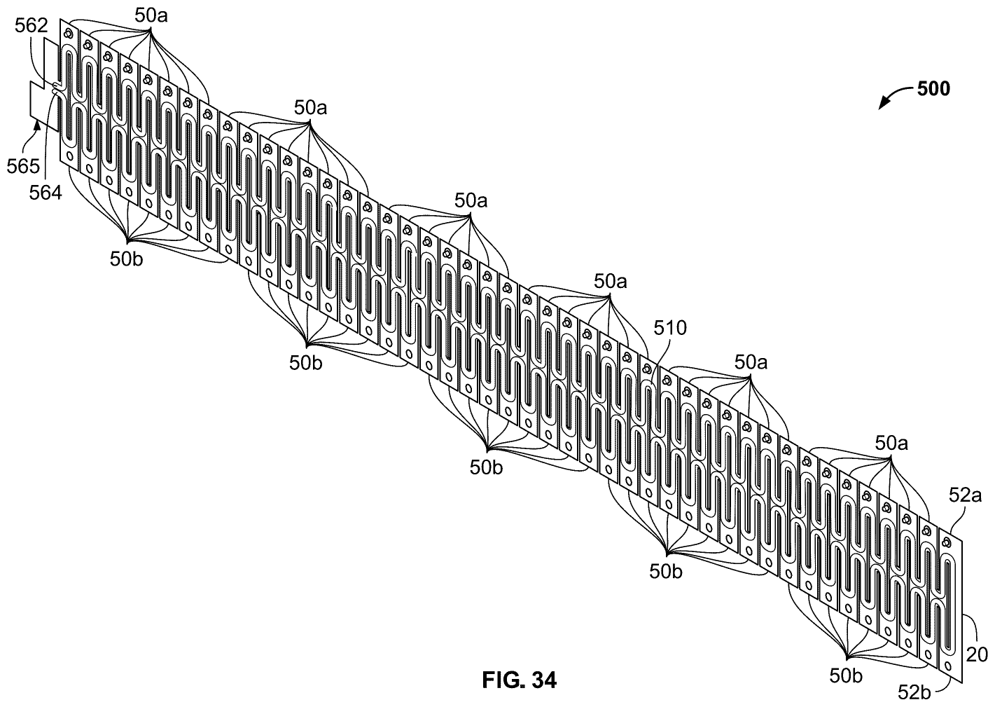

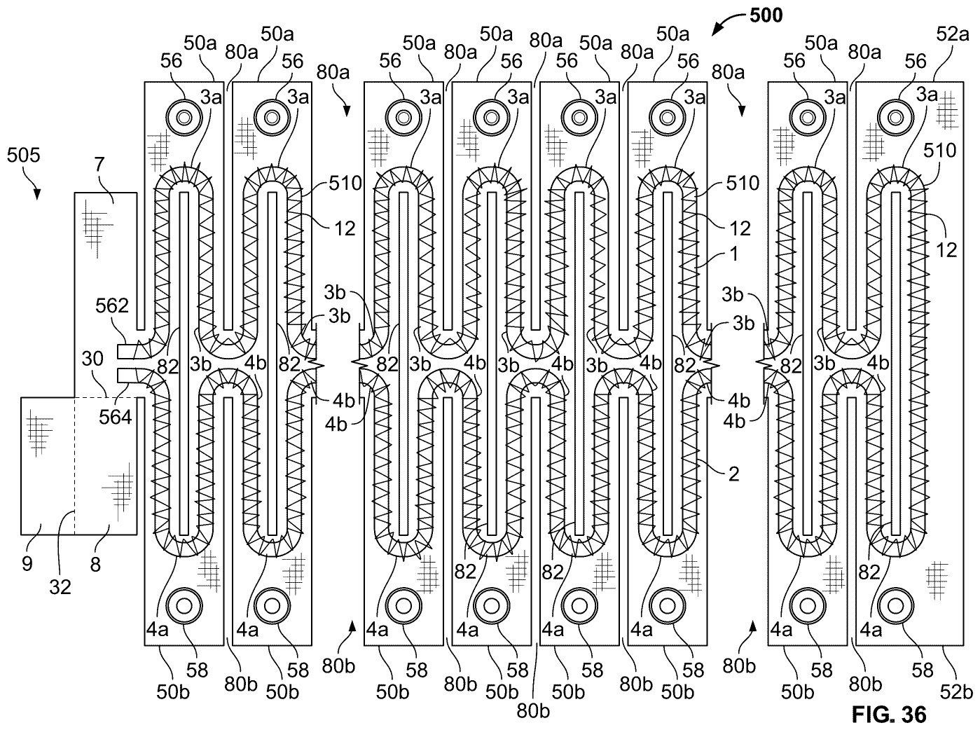

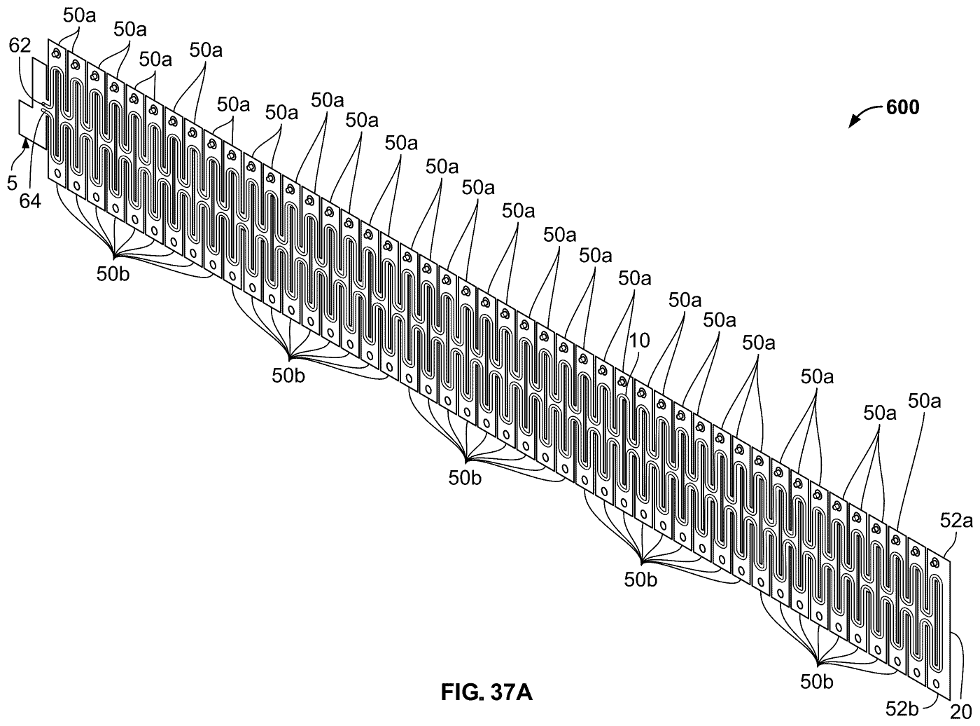

FIGS. 34-36 show electric heating element system 500 comprising self regulating-type electric heating element 510 adapted for use in accordance with the teachings of the instant disclosure. System 500 includes heating element 510 secured to substrate 20 and a terminal end 505 for connecting heating element 510 to electrical power via a pair of lead wires 65,67. As shown in FIG. 23, heating element system 500 may include an insulating blanket 96 applied over and circumferentially around heating element system 500 and pipe 99 upon which heating element system 500 is installed to aid heat distribution to the surface of the pipe. Heating element 510 is arranged on substrate 20 in a serpentine pattern, where respective portions 1,2 of heating element 510 are positioned in a pair of serpentine rows immediately adjacent one another, one above the other as shown in FIG. 36, for example, and in a continuous loop to cause both conductor ends 562,564 of heating element 510 to lie at or near terminal end 505. In this embodiment, as shown in FIG. 36, each serpentine pass or turn 3a,3b of portion 1 of heating element 510 is in symmetry with each serpentine pass or turn 4a,4b of portion 2 of heating element 510 about an imaginary centerline that longitudinally bisects substrate 20. Heating element 510 may be secured to substrate 20 via stitches 12, which may allow for an amount of movement of heating element 510 relative to substrate 20 to allow flexibility and articulation of heating element system 500 for ease of installation onto a pipe. In other embodiments, spaced apart clamps, staples, tie wraps, hooked clips, rings and belt, belt and buckles, lace and speed hooks (as typically found on boots), or any other suitable fastening means may be employed to secure heating element 510 to substrate 20.

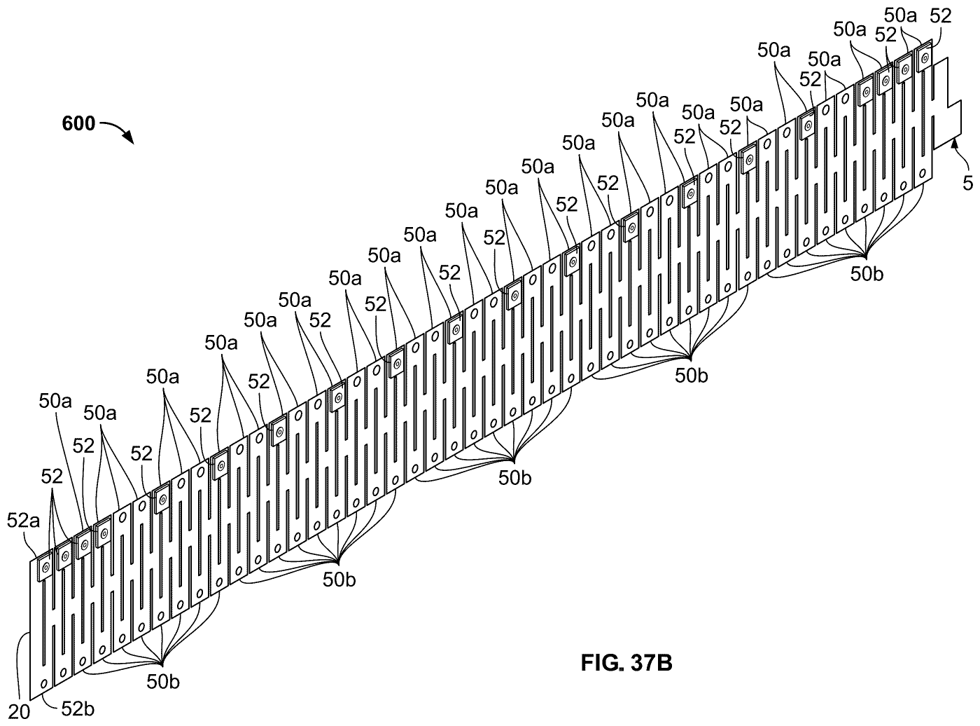

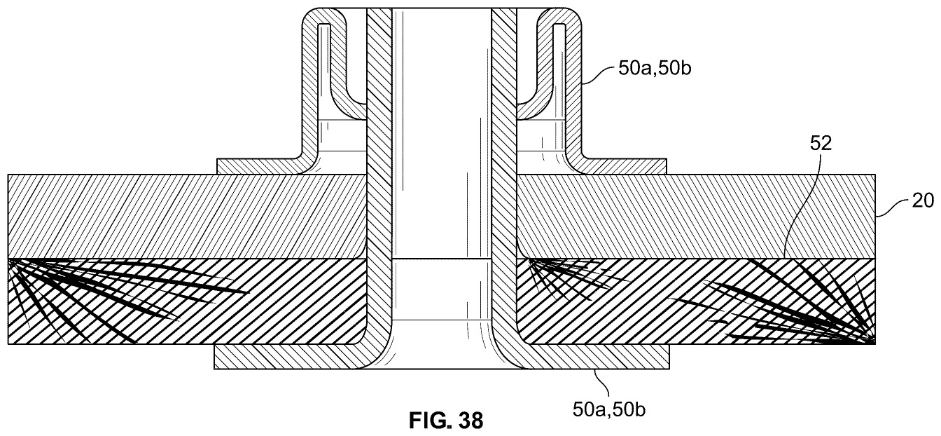

FIGS. 37A/B-38 show electric heating element system 600 comprising heating element 10 secured to substrate 20, similar to that shown in FIGS. 1-2. In this embodiment, friction squares 52 are included to prohibit or at least inhibit the substrate 20 from sliding or moving on the pipe to which system 600 is installed to help ensure that the substrate 20 remains extended along the pipe to the desired length. As shown in FIG. 37B, friction squares 52 are positioned on selected ones of fastener ends 50a and end tabs 52a of substrate 20. In other embodiments, friction squares 52 may be positioned on more or fewer numbers of fastener ends 50a and end tables 52a. As shown in FIGS. 37B-38, friction squares 52 may approximate the width of fastener ends be secured to 50a and end tables 52a. Friction squares 52 may be any suitable thickness, and in some embodiments may be approximately as thick as the thickness of substrate 20. Friction squares 52 may comprise any suitable friction-inducing material, such as silicone rubber, adhesives, or tapes. Friction squares 52 may be secured to selected ones of fastener ends 50a and end tabs 52a of substrate 20 via fastener portions 56. One of ordinary skill would appreciate that friction squares 52 may be incorporated in any of the electric heating element systems of the instant

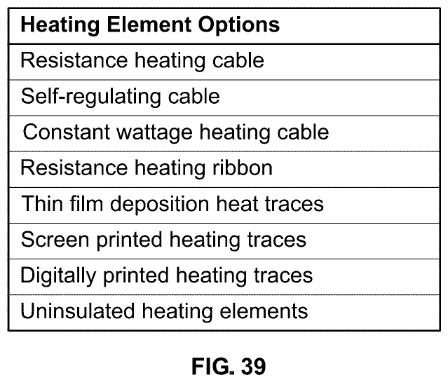

FIG. 39 illustrates an inexhaustive list of different electric heating element types that are suitable for use with the teachings of the instant disclosure. One of ordinary skill would be able to adapt these different electric heating element types with the teachings of the instant disclosure.

A mathematical expression to predict the maximum linear extension or expansion factor for heating element systems of the instant disclosure along a pipe is:

$$Maximum Expansion Factor = \frac{slot length * cos ( maximum angle of expansion )}{rib width} + 1$$

where “slot length” is the vertical length of each slot (assuming each slot has a similar length), “maximum angle of expansion” is the acute angle (assumed to be constant based on the flexibility of the material of the substrate 20) between the centerline of each “rib” measured from the longitudinal axis of the pipe, and “rib width” is the lateral width of each “rib,” which is defined as the lateral spacing between adjacent slots. In basic terms, the “slot length” is the hypotenuse in the right triangle with the longitudinal axis of the pipe, the longitudinal axis is the adjacent leg in the right triangle (the length of which is defined as the “rib width”), and the acute angle between the hypotenuse and the longitudinal adjacent leg is the “maximum angle of expansion.”

Using empirical measurements and data points, a simplified equation for estimating the maximum expansion factor based on the heating element inner diameter (i.e., pipe outer diameter) as the independent variable can be expressed as:

$$Maximum Expansion Factor = 0.6814 * ( Heater Inner Diameter ) + 0.6841$$

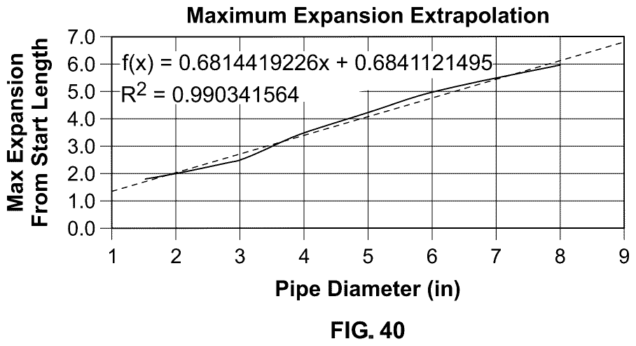

FIG. 40 provides an example illustration of the maximum predicted expansion factor of heating element systems of the instant disclosure for various pipe diameters. Using the above equation, a maximum expansion factor can be predicted for any given pipe diameter:

| | Max Expansion |
|---|---|
| Ø | Factor |
| 1.5 | 1.7 |
| 2 | 2.1 |
| 3 | 2.7 |
| 4 | 3.4 |
| 6 | 4.7 |
| 8 | 6.1 |

Thus, for a 1.5 inch diameter pipe, for example, electric heating elements of the instant disclosure can be expected to extend at least approximately 1.7 times the original, unextended length of the substrate. Similarly, for a 6 inch pipe diameter, for example, electric heating element systems of the instant disclosure can be expected to extend at least approximately 4.7 times the original, unextended length of the substrate.

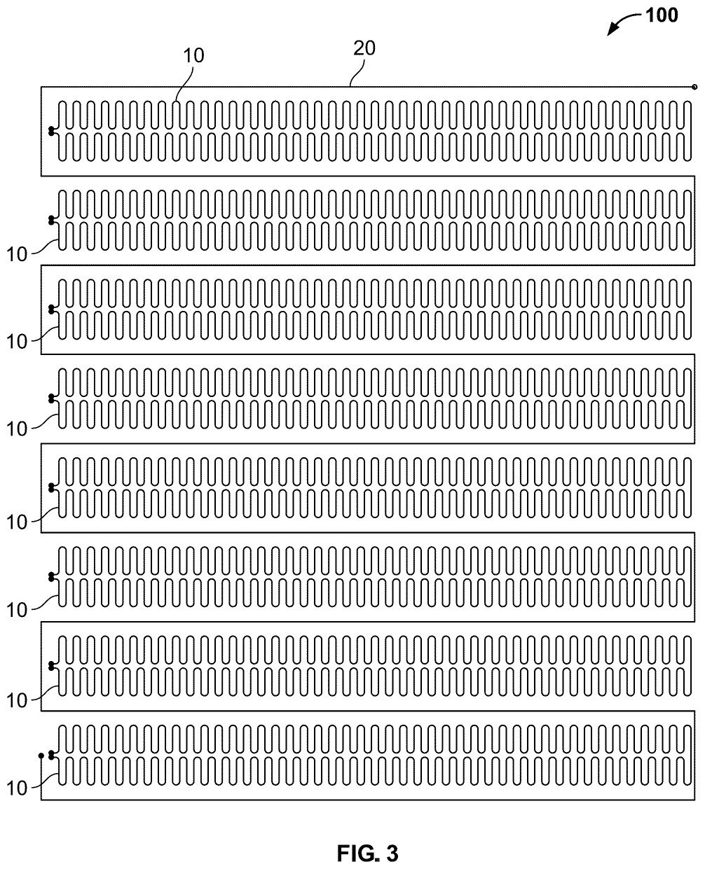

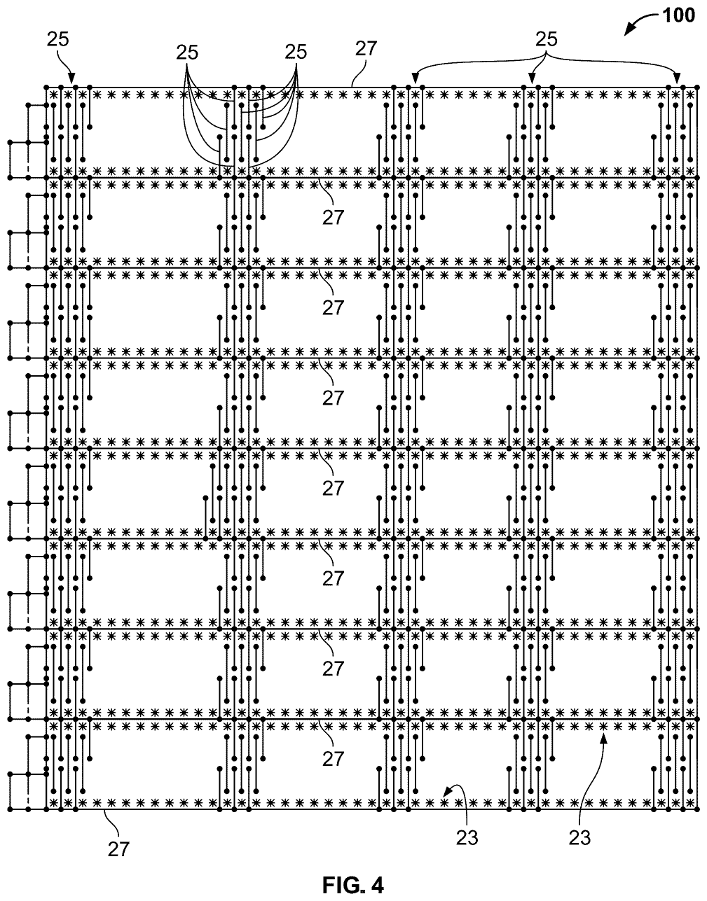

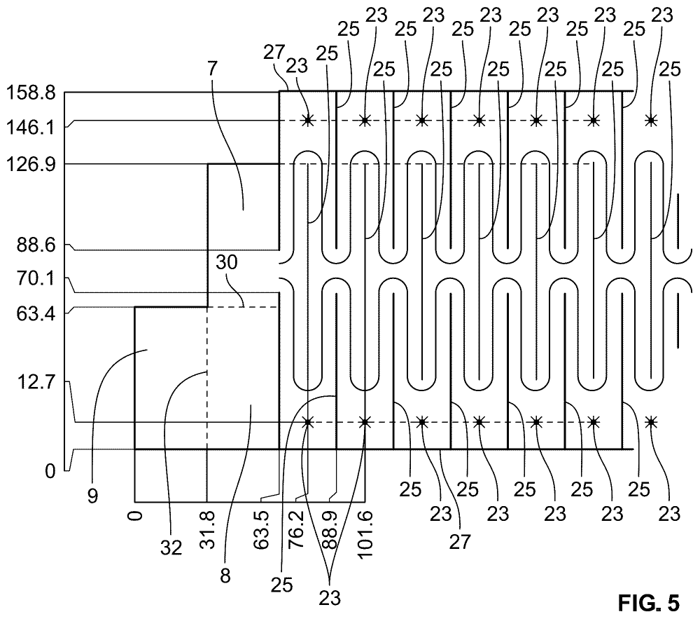

Turning to FIGS. 3-5, there are shown various steps in the method of manufacture embodiments of heating element systems 100 of the instant disclosure. For example, in the embodiment shown in FIG. 3, a Tajima sewing machine may be used to sew heating element 10 to substrate 20 using stitches 12, where multiple units of heating element 10 are positioned on multiple units of substrate 20 prior to cutting or separating the multiple units of substrate 20 from a larger substrate unit. As shown in the embodiment of FIG. 4, each of the units of substrate 20 are marked at: (i) positions 23 to locate the future position of fastener portions 56,58; (ii) positions 25 to locate future positions for slots 80a,80b and 82; and (iii) positions 27 to locate the future cut lines to separate the larger unit into multiple separate substrates 20. The process for marking all of the positions 25 continues until substrate 20 is completely marked. The next step is to hand or machine cut the larger substrate 20 into separate units of substrates 20 each with respective slots 80a,80b and 82, fastener apertures 60a,60b, and tabs 7,8,9 for terminal ends 5. In other embodiments, the tasks of marking and cutting substrate 20 may be replaced by the steps of loading the larger unit of substrate onto a laser cutting table, programming the laser cutter to cut substrate 20 according to coordinates programming into the software, and cutting the substrate 20 accordingly. The next step may be to insert fastener portions 56,58 at respective positions 23 in substrates 20. The next step may be to connect and crimp a pair of lead wires 65,67, and optionally ground wire 84 onto respective conductor ends 62,64 to form conductor junctions 72,74 (see FIGS. 8-14). As shown in the embodiment of FIG. 10, the next step may be to affix conductor junctions to substrate 20 via stitches 76a,76b and assemble sleeve 69 onto and over lead wires 65,67. The next step may be to fold tabs 7,8,9 along fold lines 30,32 and assemble tabs 7,8,9 using stitches 42a,42b as shown in the embodiment of FIGS. 11-12.

While specific embodiments have been described in detail, it will be appreciated by those skilled in the art that various modifications and alternatives to those details could be developed in light of the overall teachings of the disclosure. Accordingly, the disclosure herein is meant to be illustrative only and not limiting as to its scope and should be given the full breadth of the appended claims and any equivalents thereof.

What is claimed is:

1. An electric heating element system for heating a pipe, comprising:
an electrically resistive heating element comprising first and second electrical conductors extending from respective opposite ends of the heating element for connection to an electric power source; and
a substrate comprising a length, the substrate comprising
a first row of spaced apart slots transverse to the length;
a second row of spaced apart slots transverse to the length and laterally aligned with the first row of spaced apart slots; and
a third row of spaced apart slots transverse to the length and alternatingly positioned with the first and second rows of spaced apart slots;
wherein the first row of slots define a first row of spaced apart fastener ends, and wherein the second row of slots define a second row of spaced apart fastener ends opposite the first row of fastener ends, each of the first and second rows of spaced apart fastener ends configured to wrap transversely around an outer diameter of the pipe and comprise a fastener portion for removably attaching respective opposed fastener ends to one another to secure the substrate to the pipe,
wherein the heating element is attached to the substrate and serpentines between the first, second, and third rows of spaced apart slots from a first end to a second end of the substrate and from the second end to the first end of the substrate, wherein the first and second electrical conductors are proximate to the first end of the substrate,
wherein the first, second, and third rows of slots define rhomboid areas when the substrate is extended along the length.

2. The electric heating element system of claim 1, wherein the electrically resistive heating element comprises a self-regulating heating system.

3. The electric heating element system of claim 1, wherein the substrate comprises a heat resistant fabric, cloth, film, or mesh.

4. The electric heating element system of claim 3, wherein the fabric or cloth comprises a polytetrafluoroethylene (PTFE) coated fiberglass.

5. The electric heating element system of claim 1, wherein the substrate is approximately rectangular in plan form.

6. The electric heating element system of claim 1, wherein the first row of spaced apart fastener ends is configured to overlap with the second row of spaced apart fastener ends when wrapped around the pipe.

7. The electric heating element system of claim 1, wherein the substrate comprises a first, unextended length and is extendable up to a second, extended length.

8. The electric heating element system of claim 7, wherein the second, extended length of the substrate is at least 80% longer than the first, unextended length.

9. The electric heating element system of claim 1, wherein the first row of spaced apart slots extends from a first outer edge of the substrate along the length toward a longitudinal centerline that bisects the substrate.

10. The electric heating element system of claim 1, wherein the second row of spaced apart slots extends from a second outer edge of the substrate along the length toward a longitudinal centerline that bisects the substrate.

11. The electric heating element system of claim 1, wherein the third row of spaced apart slots extends transverse to the length from a centerline that bisects the substrate toward a first outer edge of the substrate and toward a second outer edge of the substrate.

12. The electric heating element system of claim 1, wherein each of the fastener portions comprise a snap fastener engager or a snap fastener receiver.

13. The electric heating element system of claim 1, wherein the heating element is attached to the substrate via stitches.

14. An electric heating element system for heating a pipe, comprising:
an electrically resistive heating element configured for connection to an electric power source; and
a polytetrafluoroethylene (PTFE) fiberglass substrate comprising a length, the substrate comprising
a first row of parallel slots transverse to the length;
a second row of parallel slots transverse to the length, each of the slots in the second row arranged parallel to and laterally aligned with the first row of slots;
a third row of parallel slots transverse to the length and alternatingly positioned relative to the slots in the first and second rows; and
a first row of fastener ends along the length and a second row of fastener ends along the length opposite the first row of fastener ends, the first and second rows of fastener ends defined by the first row of slots and the second row of slots, respectively, each of the first and second rows of fastener ends configured to secure the substrate to the pipe;
wherein the heating element is attached to the substrate in a serpentine pattern around each of the slots in the first, second, and third rows from a first end to a second end of the substrate and from the second end to the first end of the substrate,
wherein the substrate is adjustable in length from a first, unextended length up to a second, extended length.

15. The electric heating element system of claim 14, wherein the serpentine pattern of the heating element is repeated along the length of the substrate in a mirror image about a longitudinal centerline of the substrate.

16. The electric heating element system of claim 1, wherein the substrate comprises a first, unextended length and is adjustable up to a second, extended length.

17. The electric heating element system of claim 16, wherein the substrate is adjustable to any length from the first, unextended length up to the second, extended length.

18. The electric heating element system of claim 16, wherein the second, extended length of the substrate is up to 80% longer than the first, unextended length.

19. The electric heating element system of claim 14, wherein the first row of parallel slots extend from a first outer edge of the substrate along the length toward a longitudinal centerline of the substrate, and wherein the second row of parallel slots extend from a second outer edge of the substrate opposite the first outer edge and along the length toward the centerline, and wherein the third row of parallel slots extend transverse to the length from the centerline toward both the first and second outer edges of the substrate.

20. An electric heating element system for heating a pipe, comprising:
an electrically resistive heating element configured for connection to an electric power source; and
a substantially rectangular-shaped substrate comprising a length, the substrate comprising
a first row of slots transverse to the length;
a second row of slots transverse to the length and laterally aligned with the first row of slots;
a third row of slots transverse to the length and alternatingly positioned along the length relative to the slots in the first and second rows; and
a first row of fastener ends and a second row of fastener ends defined by the first row of slots and the second row of slots, respectively, each of the first and second rows of fastener ends configured to secure the substrate to the pipe;
wherein the heating element is attached to the substrate and serpentines around the first, second, and third rows of slots from a first end to a second end of the substrate and from the second end to the first end of the substrate,
wherein the substrate is adjustable in length from a first, unextended length up to a second, extended length.
